(19) United States
(12) Patent Application Publication
(10) Pub. No.: US 2008/0110757 A1
(43) Pub. Date: May 15, 2008

(54) Methods for manipulating separation media

(75) Inventors: Jinkyu Lee, Castro Valley, CA (US); Stephen S. Moore, Emerald Hills, CA (US); Sue Jee Bay, Foster City, CA (US)

Correspondence Address: KILYK & BOWERSOX, P.L.L.C., 3603 CHAIN BRIDGE ROAD, SUITE E, FAIRFAX, VA, 22030, US

(73) Assignee: Applera Corporation, Foster City, CA (US)

(21) Appl. No.: 11/599,653

(22) Filed: Nov. 15, 2006

(51) Int. Cl. B01D 57/02

(52) U.S. Cl. 204/453; 204/451

(57) ABSTRACT

A method of electrophoresis is provided that does not require complete replacement of an electrophoresis medium, for example, an acrylamide polymer, between each electrophoresis run. Only a small percentage of the electrophoresis medium, for example, less than 5% of the total electrophoresis medium in a capillary can be replaced in the capillary of a capillary electrophoresis apparatus prior to an electrophoresis run and show little or no degradation in the analytic capabilities of the electrophoresis system. A polymer-displacement pump system can be used for reciprocating a pump piston in a first direction to draw fresh fluid into a chamber, and reciprocating the pump piston in a second direction to cause the fresh fluid to exit the chamber and fill at least one capillary electrophoresis capillary or an array of such capillaries.

### INTRODUCTION

Prior methods of capillary electrophoresis have employed flushing and replacing of the electrophoresis medium, for example a polymer, between each electrophoresis run.

### SUMMARY

The present teachings relate to methods for manipulating separation media, for example, in the context of partially refilling one or more capillaries with a separation medium for electrophoresis. The partial refilling can result from providing less than a complete replacement volume of separation or electrophoresis medium to a capillary. The methods of the present teachings permit multiple electrophoresis runs, for example, 100 runs or more, with less than complete polymer replacement in the capillaries between each electrophoresis run. Little or no degradation in the analytic capabilities of the electrophoresis system can be observed with only partial refilling of the capillary between each electrophoresis run. The ability to replace less than the complete volume of electrophoresis medium in a capillary between electrophoresis runs can provide, inter alia, a more economical and less expensive manner to use electrophoresis medium than previous methods.

A method of electrophoresis is provided that does not require complete replacement of the electrophoresis medium, for example, a linear acrylamide polymer, between multiple electrophoresis runs. Less than a complete replacement of electrophoresis medium, for example, less than 49% of the total electrophoresis medium in a capillary can be replaced between the electrophoresis runs. Despite less than complete replacement of the electrophoresis medium between each electrophoresis run, one can still obtain reliable data, which often is similar if not identical to data obtained using more traditional methods.

In various embodiments, less than 49%, less than about 25%, or less than about 15% of a complete capillary replacement volume of electrophoresis medium can be provided to a capillary between each electrophoresis run. Unexpectedly, despite replacing significantly less than the full volume of electrophoresis medium between runs in the same capillary, data obtained from multiple electrophoresis runs was comparable to the data obtained when the electrophoresis medium when a full replacement volume of electrophoresis medium was provided to a capillary between each electrophoresis run. In various embodiments, such results can be obtained when 49% or less of the medium is replaced.

According to various embodiments, a method is provided comprising replacing less than a complete capillary volume of polymer in one capillary or each of a plurality of capillaries in a capillary electrophoresis apparatus, between multiple electrophoresis runs, and analyzing electrophoresed samples. Analysis of electrophoresed aliquots from the same sample can differ minimally or not at all between each electrophoresis run, despite less than the complete replacement of the polymer between each run or replacement after more than one few runs. The same capillary in a capillary array can be used repeatedly with less than complete polymer replacement, for example, 49% or less, for about 50 times, about 100 times, about 150 times, about 200 times, or more than about 200 times without completely replacing polymer in the capillary between each electrophoresis run.

According to various embodiments, a method is provided comprising providing an electrophoresis system comprising at least one capillary and a refilling device, the refilling device comprising a pump in fluid communication with a block, the block also in fluid communication with the at least one capillary, wherein there is no tubing between the pump and the at least one capillary, and the at least one capillary has an internal volume; filling the at least one capillary with an electrophoresis medium; electrophoresing at least one first sample in the at least one capillary; providing to the at least one capillary from the refilling device an amount of electrophoresis medium that is no more than 49% of the internal volume of the at least one capillary; and electrophoresing at least one second sample in the at least one capillary after providing the electrophoresis medium.

According to various embodiments, a method is provided comprising providing an electrophoresis system comprising at least one capillary and a refilling device, wherein the at least one capillary has an internal volume; filling the at least one capillary with an electrophoresis medium; electrophoresing at least one first sample in the at least one capillary; providing an amount of electrophoresis medium at a pressure greater than about 160 pounds per square inch from the refilling device into the at least one capillary, wherein the amount is no more than 49% of the internal volume of the at least one capillary; and electrophoresing at least one second sample in the at least one capillary after providing the electrophoresis medium.

According to various embodiments, a method is provided comprising providing an electrophoresis system comprising at least one capillary and a refilling device, wherein the at least one capillary has an internal volume; filling the at least one capillary with an electrophoresis medium; electrophoresing at least one first sample in the at least one capillary; providing electrophoresis medium continuously from the refilling device into the at least one capillary, wherein the amount of electrophoresis medium provided during the providing continuously step is no more than 49% of the internal volume of the at least one capillary; and electrophoresing at least one second sample in the at least one capillary after providing the electrophoresis medium.

According to various embodiments, a method is provided comprising electrophoresing at least one first sample in at least one capillary filled with an electrophoresis medium; detecting at least a component of the at least one first sample; replacing no more than about 15% of the total volume of the medium in the at least one capillary after electrophoresing; electrophoresing at least one second sample in the at least one capillary after replacing no more than about 15% of the total volume of the medium; and detecting at least a component of the at least one second sample.

According to various embodiments, the pump in the pump system can comprise at least one first block and an outlet opening formed in the at least one first block, a fluid chamber formed in the at least one first block and in fluid communication with the at least one outlet opening, a buffer storage container connector adapted to retain a buffer storage container in fluid communication with the fluid chamber, an electrode adjacent the buffer storage container connector and adapted to be in electrical communication with liquid in a buffer storage container when a buffer storage container is connected to the buffer storage container connector, a polymer container connector adapted to form a fluid communication with polymer in a polymer container, and a reciprocating piston pump in fluid communication with the fluid chamber and the polymer container connector.

According to various embodiments, a method is provided that can comprise reciprocating a pump piston in a first direction to draw fresh electrophoresis medium into a chamber, and reciprocating the pump piston in a second direction to cause the fresh electrophoresis medium to exit the chamber and fill a single capillary or multi-capillary array of a capillary electrophoretic analyzer. The reciprocating can comprise electrically controlling the pump piston movement.

These and other features of the present teachings are set forth herein. It is to be understood that both the foregoing general description and the following detailed description are exemplary and explanatory only and are intended to provide a further explanation of the present teachings, as claimed.

### BRIEF DESCRIPTION OF THE DRAWINGS

The drawings described below are for illustration purposes only. The drawings are not intended to limit the scope of the present teachings in any way.

FIGS. 1-6 provide data from array fill volume experiments. Conditions for the experiments are indicated for each figure. In each of FIGS. 1A-1C, 2A-2C, 3A-3C, 5A-5C, and 6A-6B, the top part of the figure is a “Box and Whisker” plot and the bottom graph of each of these figures represents the corresponding scatter plot for the data. Also indicated below are the instruments used to generate the data. In the drawings:

FIG. 1A is a plot and graph generated by Instrument C10 using a 50% array fill volume, Q20 PLOR;

FIG. 1B is a plot and graph generated by Instrument C11 using a 25% to 0% array fill volume, Q20 PLOR;

FIG. 1C is a plot and graph generated by Instrument D03 using a default array fill volume, Q20 PLOR;

FIG. 2A is a plot and graph generated by Instrument C10 using a 50% array fill volume, TET 700 CxO and 500 MT, wherein TET 700 is a DNA standard;

FIG. 2B is a plot and graph generated by Instrument C11 using a 25% to 0% array fill volume, TET 700 CxO and 500 MT;

FIG. 2C is a plot and graph generated by Instrument D03 using a default array fill volume, TET 700 CxO and 500 MT;

FIG. 3A is a plot and graph generated by Instrument C10 using no squirts, and no array fill, Q20 PLOR;

FIG. 3B is a plot and graph generated by Instrument C11 using a no squirt array, a squirt block, and no array fill, Q20 PLOR;

FIG. 3C is a plot and graph generated by Instrument D03 using a default array fill volume, Q20 PLOR;

FIG. 4A shows two graphs generated by Instrument C10 using no squirts, no array fill, and Big Dye Terminator (BDT) sequence data;

FIG. 4B shows two graphs generated by Instrument C10 using no squirts, no array fill, and TET700 sequence data;

FIG. 4C shows two graphs generated by Instrument C11 using no squirt array, a squirt block, no array fill, and BDT sequence data;

FIG. 4D shows two graphs generated by Instrument C11 using no squirt array, a squirt block, no array fill, and TET700 sequence data;

FIG. 5A is a plot and graph generated by Instrument C10 changed to a default run module, using BDT sequence data;

FIG. 5B is a plot and graph generated by Instrument C11 changed to a default run module, using BDT sequence data;

FIG. 6A is a plot and graph generated by Instrument C10 using an array fill, no squirts, and BDT sequence data;

FIG. 6B is a plot and graph generated by Instrument C11 using an array fill, no block squirt, and BDT sequence data;

FIG. 7 is a partial cross-sectional side view of a multi-capillary electrophoresis system, in partial phantom, and including an enlarged partial cross-sectional view of the injector end portion of the multi-capillary capillary array, which can be used in various embodiments; and

FIG. 8 is a partial cross-sectional side view of a polymer delivery pump system, in partial phantom, which can be used in various embodiments.

### DESCRIPTION OF VARIOUS EMBODIMENTS

It is to be understood that the following descriptions are exemplary and explanatory and in no way limit the present teachings. The accompanying drawings are incorporated in and constitute a part of this application and illustrate several exemplary embodiments with the description. Reference will now be made to various embodiments, examples of which are illustrated in the accompanying drawings. Wherever possible, the same reference numbers are used in the drawings and the description to refer to the same or like parts.

Throughout the application, descriptions of various embodiments use “comprising” language, however, it will be understood by one of skill in the art, that in some specific instances, an embodiment can alternatively be described using the language “consisting essentially of” or “consisting of.”

For purposes of better understanding the present teachings and in no way limiting the scope of the teachings, it will be clear to one of skill in the art that the use of the singular includes the plural unless specifically stated otherwise. Therefore, the terms “a,” “an,” and “at least one” are used interchangeably in this application.

Unless otherwise indicated, all numbers expressing quantities, percentages, or proportions, and other numerical values used in the specification and claims, can be understood as being modified by the term “about.” Accordingly, unless indicated to the contrary, the numerical parameters set forth in the following specification and attached claims are approximations that may vary depending upon the desired properties sought to be obtained. In some instances, “about” can be understood to mean a given value ±0.5%. Therefore, for example, “about” 100 nl, can mean 95-105 nl. At the very least, each numerical parameter should at least be construed in light of the number of reported significant digits and by applying ordinary rounding techniques.

The term “capillary” as used herein, should be understood to refer to a tube or channel or other structure for carrying out electrophoresis that is capable of supporting a volume of separation medium, such as a composition for separating analytes, as disclosed herein. The geometry of a capillary can vary widely and includes, but is not limited to, tubes with circular, rectangular or square cross-sections, channels, grooves, plates, and the like, and may be fabricated by a wide range of technologies. A feature of a capillary for use with various embodiments of the present teachings can be the surface-to-volume ratio of the surface in contact with the volume of separation medium. High values of this ratio can permit better heat transfer from the separation medium during electrophoresis. According to various embodiments, values in the range of about 0.8 to 0.02 m⁻¹ can be employed. These correspond to the surface-to-volume ratios of tubular capillaries with circular cross-sections having inside diameters in the range of about 5 μm to about 200 μm.

According to various embodiments, capillaries for use with the present teachings can be made of silica, fused silica, quartz, silicate-based glass, for example, borosilicate glass, phosphate glass, alumina-containing glass, and the like, or other silica-like materials. In various embodiments, capillaries formed from or in plastic substrates can be used. Plastic substrates can comprise, for example, polyacrylates and polyolefins, such as LUCRYL® (BASF, Germany), TPX™ (Matsui Plastics, Inc., White Plains, N. Y.), TOPAS™ (Hoechst Celanese Corp., Summit, N. J.), and ZEONOR™ (Zeon Chemicals, Louisville, Ky.). Descriptions of plastic substrates for channel capillaries can be found, among other places, in U.S. Pat. No. 5,750,015.

The term “electrophoresis medium” should be understood to mean a medium comprising sieving component and optionally, a surface interaction component. Such an electrophoresis medium can also be referred to as a separative media can be particularly useful for separating polynucleotides, or other biomolecules having different sizes but similar or identical charge-frictional drag ratios in free solution using capillary electrophoresis. The skilled artisan will appreciate that a charge-carrying component or electrolyte can typically be included in such compositions. The charge-carrying component can be part of a buffer system for maintaining the separation medium at a constant pH. The compositions for separating analytes contain one or more non-crosslinked acrylamide polymers.

The term “polymer” should be understood to mean a molecule composed of smaller monomeric or oligomeric subunits covalently linked together to form a chain. A “homopolymer” can be a polymer made up of only one monomeric repeat unit. A “copolymer” refers to a polymer made up of two or more kinds of monomeric repeat unit. Linear polymers can be composed of monomeric repeat units linked together in one continuous length to form polymer molecules. Branched polymers can be similar to linear polymers but have side chains protruding from various branch points along the main polymer. Star-shaped polymers can be similar to branched polymers except that multiple side branches radiate from a single branch site, resulting in a star-shaped or wheel-and-spoke appearance.

Acrylamide or acrylamide monomers can refer to a structure having the formula H₂C═CR—C(═O)NR₁R₂, where R can be —H or —CH₃, R₁ and R₂ can be independently —H, —CH₃, —(CH₂)ₓOH, —CH₂CH(OH)(CH₂)_{y}OR₃, —CH(CH₂OH)CH(OH)CH₃, —CH₂CH₂(OCH₂CH₂)ₚ—OR₃, —CH₂CONH₂,

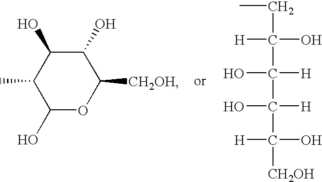

and R₃ can be independently —H, —CH₃, or —CH₂CH₃. The values for x and y range from 1 to 3 and the value of p ranges from 1 to 200.

A polymer can be cross-linked. Cross-linked polymers can contain, for example, polymer molecules that are covalently linked to each other at points other than at their ends. Crosslinking can occur during the polymerization process in the presence of crosslinking agents. At some degree of cross-linking, known as the gel point, gelation occurs. At the gel point, a visible gel or insoluble polymer forms and the system tends to lose fluidity. This crosslinked polymer gel, which corresponds to the formation of a network of polymer molecules that are crosslinked to form a macroscopic molecule, can be insoluble in all solvents, even at elevated temperatures. Discussion of acrylamide polymers and polymer gels may be found in references known in the art, for example, Odian, Principles of Polymerization, Third Edition (Wiley Interscience, 1991), incorporated by reference herein in its entirety.

The term “non-crosslinked acrylamide polymer” should be understood to refer to polymer molecules comprising acrylamide monomers, with or without branching, but excluding polymer molecules that are crosslinked together. Thus, a non-crosslinked polymer does not contain polymer molecules that are linked at points other than their end, and does not undergo gelation during polymerization. A non-crosslinked acrylamide polymer can also be referred to as a linear polymer.

Examples of polymers that can be used with the method described in the application are commercially available, and can be referred to as POPTM. POP's are readily available from Applied Biosystems, Foster City, Calif., and include, but are not limited to, POP-4™, POP-5™, POP-6™, and POP-7™. In various embodiments, other polymers can be used

The term “polynucleotide” should be understood to refer to polymers of natural or modified nucleoside monomers, including double and single stranded deoxyribonucleosides, ribonucleosides, -anomeric forms thereof, and the like. Typically, the nucleoside monomers are linked by phosphodiester bonds or analogs thereof to form polynucleotides, however, peptide nucleic acids are also contemplated. In certain embodiments, polynucleotides range in size from a few monomeric units, e.g., 20, to several thousands of monomeric units. Whenever a polynucleotide is represented by a sequence of letters, such as “ATGCCTG,” it will be understood that the nucleotides are in 5′=>3 order from left to right and that “A” denotes deoxyadenosine, “C” denotes deoxycytidine, “G” denotes deoxyguanosine, and “T” denotes deoxythymidine, unless otherwise noted. Analogs of phosphodiester linkages include phosphothioate, phosphodithioate, phosphoselenate, phosphodiselenate, phosphoroanilothioate, phosphoranilidate, phosphooramidite, and the like.

A “Polymer-Delivery Pump (PDP),” according to various embodiments of the present teachings, can provide users with an easier, automated way to install polymer into a capillary or a capillary electrophoresis system as compared to syringe-based systems. A PDP can, in various embodiments, provide for a more streamlined workflow and can reduce the downtime from issues that can occur with a syringe system. In various other embodiments, however, a syringe can be used instead of the polymer delivery pump to replace electrophoresis media in a capillary or a capillary arena. A polymer delivery pump can also be considered to be a “refilling device,” however, a refilling device does not necessary have to be a polymer-delivery pump. For example, a syringe or syringe-type device can also be a refilling device.

“Not significantly affected,” “not significantly degraded,” “not degraded,” and similar phrases should be understood to mean that if aliquots of the same sample are run more than once in the same capillary, the analysis of the aliquots can be similar between each run. This does not, however, mean that such data need be identical between each run. For example, parameters that can be measured or detected can comprise a quality control score and/or the resolution of adjacent peaks during each run and/or the migrative time of samples of interest. Such parameters are not degraded and/or the peak patterns can be similar to that observed after the initial electrophoresis of an aliquot of the same sample. This should also be understood to mean that differences in the analysis of samples or detection of components can occur between each run, however, the basic information from any analysis will still be readily interpretable. According to various other embodiments, there may be degradation between multiple runs in the same capillary when less than the complete volume of the electrophoresis medium is replaced.

The “quality control score” should be understood to represent the percentage of incorrect base calls, for example, when analyzing a sequence. Base calls are the reading off of the bases in a sequence being analyzed. A quality control score, for example, a Q20 PLOR score, can represent 1 incorrect base call per 100 base calls.

This application relates to methods for repeatedly performing electrophoresis in the same capillary with less than complete replacement of the electrophoresis medium between each electrophoresis run. This can result in savings in terms of consumables, in particular, savings in the cost or replacing electrophoresis medium. It can also provide savings in terms of the time necessary to perform multiple electrophoresis runs. The method can further provide accurate data determination and/or detection of components of interest in each electrophoresis run, despite minimal replacement of the electrophoresis medium between each run. In various embodiments, for example, the application provides an electrophoresis method useful with an electrophoresis separation medium such as, for example, a flowable sieving polymer.

According to various embodiments a method is provided that can comprise providing an electrophoresis system wherein the electrophoresis system can comprise at least one capillary and a refilling device, the refilling device can comprise a pump in fluid communication with a block wherein the block can also be in fluid communication with the at least one capillary and there is no tubing between the pump and the at least one capillary, and the at least one capillary has an internal volume; filling the at least one capillary with an electrophoresis medium; electrophoresing at least one first sample in the at least one capillary; providing to the at least one capillary from the refilling device an amount of electrophoresis medium that is no more than 49% of the internal volume of the at least one capillary; and electrophoresing at least one second sample in the at least one capillary after providing the electrophoresis medium. In various embodiments, the at least one capillary can be inserted directly into the block or into an attachment device that is attached to the block.

According to various embodiments, providing electrophoresis medium can comprise injecting electrophoresis medium into the at least one capillary. Other methods of providing electrophoresis medium can also be used. In various embodiments, the at least one capillary can be provided with no more than about 25%, no more than about 50%, or no more than about 75% of the total internal volume of electrophoresis medium.

Providing new medium to a capillary does not necessary result in a one-to-one displacement or replacement of the medium already present in a capillary, however, in various embodiments providing not more than 49% of the total volume of electrophoresis medium can result in replacing the same volume of the electrophoresis medium that was already present in the at least one capillary.

According to various embodiments, the providing of electrophoresis medium can occur at a pressure greater than about 160 pounds per square inch, greater than about 300 pounds per square inch, greater than about 600 pounds per square inch, or greater than about 1000 pounds per square inch.

According to various embodiments, the electrophoresis medium can be an acrylamide polymer. The acrylamide polymer can be a non-crosslinked polymer.

According to various embodiments, replacing not more than 49% of the total volume of electrophoresis medium can comprise pumping the electrophoresis medium from the refilling device with a pump system, wherein the pump system can comprise the pump and the block, wherein an outlet opening and a fluid chamber is formed in the block and the fluid chamber is in fluid communication with the outlet opening; a buffer storage container connector adapted to retain a buffer storage container in fluid communication with the fluid chamber; a polymer container connector adapted to form a fluid communication with polymer in a polymer container; and a reciprocating piston pump in fluid communication with the fluid chamber and the polymer container connector.

According to various embodiments, a method is provided comprising providing an electrophoresis system, wherein the electrophoresis system comprises at least one capillary and a refilling device, the at least one capillary having an internal volume; filling the at least one capillary with an electrophoresis medium; electrophoresing at least one first sample in the at least one capillary; providing an amount of electrophoresis medium at a pressure greater than about 160 pounds per square inch from the refilling device into the at least one capillary, wherein the amount of electrophoresis medium that is replaced is no more than 49% of the internal volume of the at least one capillary; and electrophoresing at least one second sample in the at least one capillary after providing the electrophoresis medium. In various embodiments, the pressure can be greater than about 300 pounds per square inch, greater than about 600 pounds per square inch, or greater than about 1000 pounds per square inch.

According to various embodiments, the providing of electrophoresis medium in the above method can comprise injecting electrophoresis medium. Other methods of providing electrophoresis medium, however, can also be used. In various embodiments, the electrophoresis medium replaced in at least one capillary can be no more than about 25%, no more than about 50%, or no more than about 75% of the total internal volume of the at least one capillary.

According to various embodiments, a method is provided comprising: electrophoresing at least one first sample in at least one capillary filled with an electrophoresis medium; detecting at least a component of the at least one first sample; replacing no more than about 15% of the total volume of the electrophoresis medium in the at least one capillary after the electrophoresing; electrophoresing at least one second sample in the at least one capillary after the replacing of no more than about 15% of the total volume of the electrophoresis medium; and detecting at least a component of the at least one second sample. In various embodiments, the detecting of at least a component of the at least one first sample, detecting at least a component of the at least one second sample, or detecting a component of both samples can occur during the electrophoresing. The electrophoresis medium can comprise a polymer. The polymer can comprise an acrylamide polymer. The acrylamide polymer can comprise a linear polymer, a cross-linked polymer, a non-cross-linked polymer, a blend or combination thereof, or the like.

According to various embodiments, less than about 10% or less than about 5% of the total volume of the electrophoresis medium can be replaced. In various other embodiments, a fresh volume of no more than 49% of the total volume of the electrophoresis medium already present in a capillary, can be provided to that capillary. The providing of no more than 49% of the total volume of electrophoresis medium can result in replacement of less than 49% the medium already present in the capillary, for example, replacement of about 30% or less of the medium.

According to various embodiments, the at least one capillary used in the method can comprise a plurality of capillaries. The at least one first sample in the method can comprise a plurality of different first samples, each in a different respective capillary of the plurality of capillaries. In other embodiments, the at least one first sample can comprise the aliquists of the same sample, each in a different respective capillary.

In various embodiments, the method can further comprise electrophoresing additional samples in the at least one capillary and detecting at least a component of each of the additional samples, wherein no more than about 15% of the total volume of the electrophoresis medium in the at least one capillary is replaced after each respective electrophoresing of each of the additional samples, and the detecting of at least a component of the at least one second sample and the detecting of at least a component of each of the additional samples are not significantly degraded relative to the detecting of at least a component of the at least one first sample. In various embodiments, the electrophoresing of the method can be repeated at least about 50 times or more without replacing more than 15% of the total volume of the electrophoresis medium between each electrophoresing. In various embodiments, the electrophoresis can be repeated at least about 300 times or more without replacing more than 15% of the total volume of the electrophoresis medium between each electrophoresing. In other embodiments, less than 49% of the total volume of electrophoresesis medium can be replaced between each electrophoresing. In various embodiments, the electrophoresis can be repeated at least about 200 times or at least about 100 times.

According to various embodiments, the additional samples and the at least one first sample can comprise aliquots of the same sample and analytic information obtained from the electrophoresing of the additional samples is about the same as that obtained from similar electrophoretic analyses of the at least one first sample. The analytic information can comprise a quality score. The quality score can comprise a Q20 PLOR score. Other quality scores can also be used to provide analytic information.

According to various embodiments, the at least one first sample and the at least one second sample can comprise different portions of the same sample, the detecting at least a component of the at least one first sample can comprise obtaining a first quality score, the detecting at least a component of the at least one second sample can comprise obtaining a second quality score, and the first quality score can be about the same as the second quality score.

According to various embodiments, the at least one first sample can comprise an oligonucleotide of a known size and the at least one second sample comprises an oligonucleotide of the same size. In various embodiments, the oligonucleotides can be different sizes. The oligonucleotide can comprise a DNA fragment. The DNA fragment can comprise from about 10 to about 1000 base pairs. In various embodiments, the DNA fragment can comprise from about 10 to about 100 base pairs, from about 100 to about 500 base pairs, from about 500 to about 1000 base pairs, or greather than 1000 base pairs.

According to various embodiments, the replacing of not more than about 15% can comprise replacing not more than from about 1% to about 5%, not more than from about 5% to about 10%, or not more than about 10% to about 10% to about 15%, of the electrophoresis medium in the at least one capillary after electrophoresing the first sample.

According to various embodiments, a method is provided comprising: electrophoresing at least one first sample in at least one capillary filled with an electrophoresis medium; detecting at least a component of the at least one first sample; replacing less than 49% of the total volume of the electrophoresis medium in the at least one capillary after the electrophoresing; electrophoresing at least one second sample in the at least one capillary after the replacing less than 49% of the total volume of the electrophoresis medium; and detecting at least a component of the at least one second sample. The electrophoresis medium can comprise an acrylamide polymer. The polymer can comprise an acrylamide polymer. The acrylamide polymer can comprise a linear polymer or a cross-linked polymer.

According to various embodiments, the method can further comprise electrophoresing additional samples in the at least one capillary and detecting of at least one component of the additional sample, wherein less than 49% of the total volume of the electrophoresis medium in the at least one capillary is replaced after each respective electrophoresing of each of the additional samples, and the detecting of at least a component of the at least second sample and the detecting of at least a component of each of the additional samples are not significantly degraded relative to the detecting of at least a component of the at least one first sample. The at least one capillary can comprise a plurality of capillaries. The at least one first sample can comprise a plurality of different first samples, each in a different respective capillary.

In various embodiments, the electrophoresis can be repeated at least about 300 times or more replacing less than 49% of the total volume of the electrophoresis medium between each electrophoresing.

According to various embodiments, the additional samples and the at least one first sample can comprise aliquots of the same sample and analytic information obtained from the electrophoresing of the additional samples is about the same as that obtained from similar electrophoretic analyses of the at least one first sample. The analytic information can comprise a quality score. The quality score can comprise a Q20 PLOR score.

According to various embodiments, the at least one first sample and the at least one second sample can comprise different portions of the same sample, the detecting at least a component of the at least one first sample can comprise obtaining a first quality score, the detecting at least a component of the at least one second sample can comprise obtaining a second quality score, and the first quality score can be about the same as the second quality score.

According to various embodiments, the at least one first sample can comprise an oligonucleotide of a known size and the at least one second sample comprises an oligonucleotide of the same size. The oligonucleotide can comprise a DNA fragment. The DNA fragment can comprise from about 10 to about 1000 base pairs. In various embodiments, the DNA fragment can comprise from about 10 to about 100 base pairs, from about 100 to about 500 base pairs, from about 500 to about 1000 base pairs, or greather than 1000 base pairs.

According to various embodiments, replacing less than 49% can comprise replacing from about 25% to 49%, from about 20% to about 40%, or less than about 20% of the electrophoresis medium in the at least one capillary after electrophoresing the first sample.

According to various embodiments, replacing less than 49% of the total volume of the electrophoresis medium can comprise pumping the electrophoresis medium with a pump system, the pump system can comprise: a first block, an outlet opening formed in the first block, a fluid chamber formed in the first block, the fluid chamber in fluid communication with the outlet opening, a buffer storage container connector adapted to retain a buffer storage container in fluid communication with the fluid chamber; a polymer container connector adapted to form a fluid communication with polymer in a polymer container; and a reciprocating piston pump in fluid communication with the fluid chamber and the polymer container connector. In various embodiments, not more than about 15% of the total volume of the electrophoresis medium can be replaced.

According to various embodiments, less than about 10% or less than about 5% of the total volume of the electrophoresis medium can be replaced. In various other embodiments, no more than 49% of the total volume of the electrophoresis medium already present in a capillary can be provided to that capillary. The providing of 49% of the total volume of electrophoresis medium can result in replacement of less than 49% the medium already present in the capillary, for example, replacement of about 30% or less of the medium.

According to various embodiments, the pump system can further comprise an electrode adjacent to the buffer storage container connector and adapted to be in electrical communication with liquid in a buffer storage container when a buffer storage container is connected to the buffer storage container connector. In various embodiments, the pump system can further comprise a buffer jar connected to the buffer storage container connector, wherein the first block comprises a first fluid communication between the fluid chamber and the buffer jar.

According to various embodiments, the pump system can further comprise a second fluid communication, wherein the polymer container connector comprises a check valve and the second fluid communication fluidly communicates the check valve and the pump.

According to various embodiments, the reciprocating piston pump in the pump system can comprise a piston and a chamber, and the reciprocating piston pump is adapted to reciprocate the piston in the chamber. The piston in the pump system can comprise one or more of a gemstone material and a ceramic material. The gemstone can comprise sapphire.

According to various embodiments, the replacing in the method can comprises: reciprocating a pump piston in a first direction to draw fresh fluid into a chamber; and reciprocating the pump piston in a second direction to cause the fresh fluid to exit the chamber and fill the at least one capillary, wherein the reciprocating comprises electrically controlling the pump piston movement. In various other embodiment, the replacing in the method can comprise: reciprocating a pump piston in a first direction to cause not more than about 10% fresh medium, for example, 49% fresh medium, or to cause less than about 100% fresh electrophoresis medium to be received into a chamber; and reciprocating the pump piston in a second direction to cause the fresh electrophoresis medium to exit the chamber and enter the at least one capillary, wherein the reciprocating comprises controlling the pump piston movement using a programmable controller. The programmable controller is adapted to control a current to a stepper motor.

The methods and apparatus described in this application can be employed in connection with a variety of electrophoresis systems. As non-limiting examples, the present teachings can be adapted for use in connection with methods and apparatus such as those described in patent publications Nos. WO2003/027028 A1, US2003/0221965 A1, US2001/0040095 A1, US2003/0226756 A1, US2003/0127328 A1, US2004/0000481 A1, US2003/0201180 A1, US2004/0018638 A1, US2001/0040094 A1, US2002/0023839 A1, US2002/0003091 A1, and US2002/0179446 A1, each of which is hereby incorporated herein by reference in its entirety.

Additional details about electrophoresis mediums that can be used with the methods of the present teachings can be found, for example, in U.S. pat. No. 5,173,163, U.S. Pat. No. 6,706,162 B1, WO 2004/104054 A1, and WO 2004/011513, all of which are incorporated by reference herein in their entireties. Examples of capillary electrophoresis analyzers that can be used in various embodiments comprise an ABI 310, ABI 3130, ABI 3130x1, ABI 3700, ABI 3730, or ABI 3730x1 (available from Applied Biosystems, Foster City, Calif.).

According to various embodiments the method can use compositions comprising a non-crosslinked acrylamide polymer sieving component. In other embodiments, compositions can further comprise a surface interaction component, such as polydimethylacrylamide (pDMA). Non-crosslinked acrylamide polymers can comprise, for example, linear polymers such as polyacrylamide (LPA), branched polymers, and star-shaped polymers. Additional details concerning polymers that can be used in the methods of the present teachings can be found in U.S. Pat. No. 6,706,162 B1, incorporated herein by reference in its entirety.

The application provides methods of performing electrophorosis using a capillary that can be part of a capillary array. The methods can provide improved productivity, and/or decreased time of analysis and/or reduced use of polymer over multiple electrophoretic runs. Unexpectedly, the methods can provide little or no decrease or degradation in the analytic capabilities of a capillary electrophoresis system, or the analytic information obtained from multiple electrophoresis runs.

According to various embodiments, the methods of the present teachings can be performed in a capillary electrophoresis device that can comprise a capillary array. Additionally, in various embodiments, the capillary electrophoresis device can comprise a sample tray, a power supply unit, and/or an optical system. The capillary in the capillary array can be a replaceable member and can include a plurality of capillaries for conducting electrophoretic separation of a sample to be analyzed. The capillaries of the array can be replaceable, and the use of a capillary array can allow easy installation of capillaries onto a main body of a capillary electrophoresis device. The sample tray can be a container that can hold one or more samples for examination. The power supply unit can be a mechanism that generates an electric field for conducting electrophoretic separation of the sample. The optical system can be a mechanism that can excite a fluorescent sample and detect the emitted fluorescence.

According to various embodiments, a capillary used in the methods of the present teachings can be a capillary in a capillary array that can comprise a plurality of capillaries. The capillary array can be part of a capillary electrophoresis system. Additional components of the capillary electrophoresis system can comprise, one or more of, a load header, a capillary head, a detection cell, and one or more separators. The capillary array can be a replaceable member that can be connected to the main body of the electrophoresis device in a quick-connecting and disconnecting manner. After several months of use, or after several hundred cycles of electrophoresis operation, if the ability of the capillary array to separate samples becomes reduced, the capillary array can then be disposed.

According to various embodiments, a capillary can be a hollow member that can be capable of electrophoretic separation of samples. The capillaries can be made of a fused-silica pipe, for example, and can have an outer diameter of about 0.15 mm and inner diameter of about 0.05 mm. The outside surface of each capillary can be coated with a resin coating, such as polyimide. The capillaries can include a light-illuminable portion that can be illuminated with light, such as a laser beam. At the light-illuminable portion, the coating is not applied or can be removed. A separation medium can be injected into the capillary using, for example, a pump or syringe. During electrophoresis, the separation medium can promote differences in electrophoretic separation.

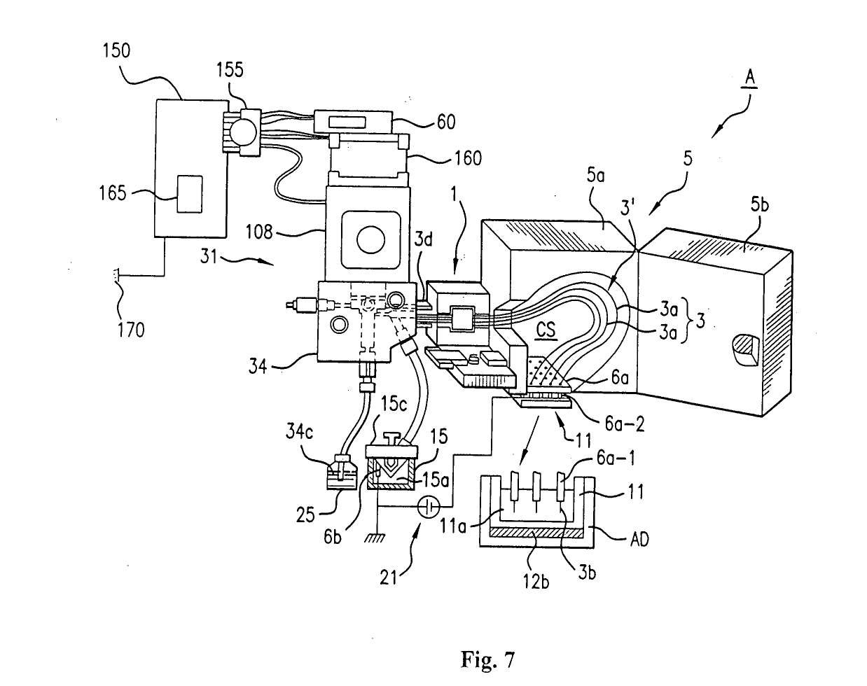

FIG. 7 illustrates a multi-capillary electrophoresis system that can be used in various embodiments of the methods which involve minimal electrophoresis medium addition between each electrophoresis run. The multi-capillary electrophoresis system can include a single capillary or multi-capillary array 3 comprising plural capillaries 3a installed in a container portion CS of a temperature regulated chamber 5. Single capillary or multi-capillary array 3 can comprise plural, for example, 96 capillaries 3a. A sample containing, for example, DNA molecules, and an electrophoresis medium can be filled in the capillaries 3a. In various embodiments, the electrophoresis medium can comprise, for example, a polymer in a gel form. DNA fragments in the sample can be distinguished by labeling a primer or terminator with a fluorescent substance. The DNA fragments thus labeled with a fluorescent substance can be distinguished by optical means as described, for example, in U.S. Published Patent Application No. US 2003/0102221 A1, filed Sep. 18, 2002 and assigned U.S. application Ser. No. 10/245,492, which is hereby incorporated, in its entirety herein, by reference.

According to various embodiments, one end of the capillary 3a can comprise an injecting end 3b for injecting a sample by protruding injecting end 3b from a bottom of temperature regulated chamber 5. Injecting end 3b can be immersed in a buffer solution that can be contained in buffer container 11. Electrodes 6a-1 can be mounted on or near injecting ends 3b of capillaries 3a. Electrodes 6a-1 can be made in electrical contact with an electrode plate 6a comprising, for example, an electrically conducting material. Electrode plate 6a can comprise, for example, platinum, copper, stainless steel, or an electrically conductive filled rubber material. In various embodiments, electrode plate 6a on the side of injecting ends 3b can be formed by pressing stainless-steel or platinum tubes 6a-1 into metallic plate 6a-2, for example, into a metal material plate or another electrically conducting material plate. Other embodiments are also possible.

Injecting end 3b can be inserted in stainless-steel tubes 6a-1 to integrate sample injecting end 3b and electrode plate 6a. A positive electrode can be connected to electrode plate 6a through an electrode (not shown in the figure) of the system. The electrophoresis medium can be filled in capillaries 3a, and the sample can be filled in the vicinity of injecting end 3b. Injecting end 3b and electrode 6a can be immersed in the buffer solution 11a filled in buffer container 11. In various embodiments, buffer solution 11a can comprise, for example, TBE (a mixed solution of tris (hydroxymethyl) aminomethane, boric acid and EDTA (ethylenediaminetetraacetic acid)) or TAPS (N-tris(hydroxymethyl)methyl-3-aminopropanesulfonic acid).

The buffer container 11 can be installed in an adapter AD. The adapter AD can comprise a rubber heater 12b, a thin film heater, a KELVAR sandwich heater, a Peltier heating device, or the like, disposed on the inner bottom surface thereof.

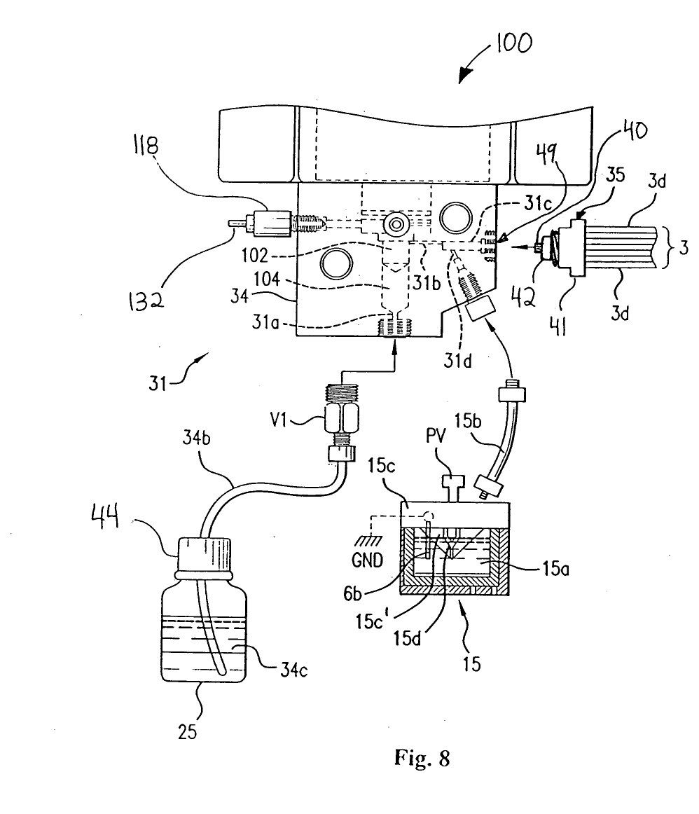

According to various embodiments, the other end of capillary 3a can protrude from a side opening of temperature regulated chamber 5 and through detector assembly 1 for detecting components of a sample. A plurality of these end parts can be packed at a capillary fixing part or connector 35 (FIG. 8), which can comprise, for example, a ferrule 42 (FIG. 8) and a knob 41 (FIG. 8). End parts can be connected to a block, for example, upper polymer block (also referred to as a pump block) 34. For example, capillary array end parts 40, can comprise, according to some embodiments, a sealed, dense bundle of capillaries, which can be fitted by a user with threaded array knob 41 (FIG. 8) and double-tapered ferrule 42 (FIG. 8), which together form a high-pressure seal when the array knob is attached to polymer block 34. In some embodiments, the system can connect to a single capillary as opposed to a multi-capillary array.

In various embodiments, upper polymer block 34 can be connected to a buffer storage container (for example, a buffer jar) 15 holding buffer solution 15a therein, polymer storage container (for example, a polymer bottle) 25 holding a polymer therein, for example, electrophoresis medium 34c, and Polymer-Delivery Pump (PDP) 31. Polymer storage container 25 can comprise a supply bottle and bottle cap 44 (See FIG. 8) with a hole permitting passage of a polymer supply tube therethrough.

In various embodiments, a capillary electrophoresis system, to be used in the disclosed methods, can separately control the temperature of different components or regions of capillary electrophoresis system A. For example, a thermostat oven can be provided to contain one or more electrophoresis capillaries. A housing can be provided to contain at least one of pump block 34, buffer storage container 15 and PDP 31. Further details regarding temperature control for capillary electrophoresis system A are described, for example, in U.S. Published Patent Application No. US 2003/0102221 A1, the disclosure of which has been incorporated herein in its entirety, by reference. For example, in various embodiments the multi-capillary electrophoresis system A can comprise one or more temperature controlling parts (not shown) for controlling the temperature of capillaries 3a with thermostat oven (temperature-controlled chamber) 5 of the container portion CS.

In various embodiments, PDP 31 can comprise pump displacement motor housing 108, stepper motor 160, encoder 60, and controller 150. Stepper motor 160 can be coupled to pump displacement motor housing 108. Stepper motor 160, pump displacement motor housing 108, and encoder 60 can be coupled to controller 150 using controller connector 155. Stepper motor 160 can be coupled to pump displacement motor housing 108 with a screw drive to convert rotational movement to translational movement. In various embodiments, controller 150 can comprise electrical devices and components contained on a Printed Circuit Board (PCB). In various embodiments, controller 150 can be provided in communication with a computing system (not shown) via computer/network interface 170. In various embodiments, computer/network interface 170 can be, for example, an Ethernet interface. In various embodiments, controller 150 can be configured to control the operation of stepper motor 160 and pump displacement motor housing 108 of the PDP 31 for polymer fill operations as described herein. In various embodiments, controller 150 can comprise firmware 165 in which is embodied a sequence of programmed instructions that, when executed by controller 150, cause controller 150 to perform the operations described herein. In some embodiments, controller 150 can respond to commands received via computer/network interface 170. Controller 150 can output status and other information via computer/network interface 170. In various embodiments, controller 150 can be coupled to encoder 60 for monitoring operation of stepper motor 160. In various embodiments, the above-described system can regulate addition of polymer to appropriate components. The regulation of polymer additive can result in partial filling of a capillary or capillaries in a capillary electrophoresis system.

For example, the polymer can comprise one or more of linear polyacrylamide, various derivatives of cellulose (e.g., MC, HPMC, etc.), galactomannan, glucomannan, polyvinyl alcohol, polyethyleneoxide, agarose, dextran, polydimethylacrylamide, polyhydroxypropylacrylamide, and/or polyacryloylethoxyethanol. In some embodiments, the polymer is a member of the POP™ polymer family, such as POP-4, POP-5, POP-6, or POP-7 available from Applied Biosystems of Foster City, Calif. In some embodiments, the polymer can comprise one or more of the polymers disclosed in U.S. Pat. Nos. 5,427,729; 5,181,999; 5,015,350; 5,164,055; 5,126,021; 5,264,101; 5,759,369; 5,468,365; 5,290,418; 6,051,636; 5,891,313; 5,374,527; 5,916,426; 6,355,709 B1; 5,567,292; 6,358,385 B1; 6,297,009 B1; 5,578,179; and 6,706,162 B1; and/or in U.S. patent applications Ser. Nos. 10/843,114 and 10/629,524, all of which are incorporated herein in their entireties by reference.

In various embodiments, the polymer can have a viscosity of at least about twice the viscosity of water. In other embodiments, the polymer can have a viscosity greater than twice the viscosity of water. In various other embodiments, the polymer can have a viscosity of from about 150 to about 550 times the viscosity of water, for example, from about 150 to about 300 times the viscosity of water.

According to various embodiments, DNA fragments contained in a sample can be distinguished by labeling a primer or a terminator with a fluorescent substance such as, for example, a dye. Examples of such fluorescent dyes include, but are not limited to, the 5FAM, JOE, TAMRA, and/or ROX dyes available from Applied Biosystems of Foster City, Calif. Distinguishing of DNA fragments in this manner can be accomplished, for example, using the Sanger dideoxy method. The labeled DNA fragments can be detected utilizing a suitable optical system. According to some embodiments, a light source or light emission component such as, for example, a laser or Light Emitting Diode (LED) emits radiation (e.g., light) that excites the fluorescent dyes of the DNA fragments. A Charge Coupled Device (CCD) or photodiode can be provide for receiving the light then emitted by the fluorescent dyes.

FIG. 8 is a partial cross-sectional side view in partial phantom of a polymer delivery pump system 100 that can be used to carry out the methods described herein, according to various embodiments. With regard to FIG. 8, polymer delivery pump system 100 can comprise upper polymer block 34, a polymer-delivery pump connected to upper polymer block 34, and lower polymer block 15c (see FIG. 8) connected to upper polymer block 34. Polymer delivery pump 31, polymer storage container 25 and buffer storage container 15 can be connected to upper polymer block 34. Flow paths, such as 31a to 31d, can be formed in upper polymer block 34. When the valve PV is closed, the flow of polymer can travel through tip 40 into single capillary or multi-capillary array 3. Closure of the PV can result in a polymer “squirt” and/or an array fill In some embodiments, a single block can be used instead of an upper block and a separate lower block.

The polymer-delivery pump can comprise pump displacement motor housing 108 and pump piston 102. Upper polymer block 34 can comprise fluid chamber or pump chamber 104 adapted to receive pump piston 102 and to permit reciprocating movement of pump piston 102 therein. Water trap 118 can be formed in upper polymer block 34 by a first seal and a second seal. In various embodiments, the seals can be annular seals that surround pump piston 102 in upper polymer block 34.

In various embodiments, upper polymer block 34 can comprise, for example, a block formed of an acrylic resin. Upper polymer block 34 can be adapted to receive pump piston 102 into chamber 104. Upper polymer block 34 can comprise flow paths 31a through 31d, array port 49, and mounting pins. Upper polymer block 34 can also comprise Luer® fitting to provide access to water trap 118, and an exit port for draining water from the water trap 118 via exit port fitting 132.

Capillary array tip 40 of single capillary or multi-capillary array 3 can be connected to upper polymer block 34 at array port 49 using connector 35 which can comprise, for example, double-tapered ferrule 42 and knob 41 assembly.

Lower polymer block 15c can be connected to upper polymer block 34 via flow path 15b. Flow path 15b can comprise interconnect tubing fixedly attached to upper polymer block 34 and lower polymer block 15c. In various embodiments, flow path 15b can comprise a sidewall that exhibits a surface energy of about 30 dynes/centimeter or more. Lower polymer block 15c can comprise pin valve PV. In various embodiments, buffer storage container 15 holding buffer solution 15a therein can be fixedly attached to lower polymer block 15c. Buffer storage container 15 can comprise, for example, a buffer fill line and an overflow hole. Lower polymer block 15c can comprise O-ring seal for forming a leak-free seal between lower polymer block 15c and buffer storage container 15. Lower polymer block 15c can also comprise a buffer solution flow path, a protrusion part 15c′ protruding downwardly with respect to lower polymer block 15c, and pin valve PV for opening and shutting an end opening 15d of the buffer flow path. A tip end of the pin valve PV can reach the interior of protrusion part 15c′. Lower polymer block 15c can also comprise electrode 6b comprising a tip end.

Polymer storage container (for example, a polymer bottle) 25 holding a polymer, for example, electrophoresis or separation medium, 34c therein, can be connected to upper polymer block 34 using a flow path 34b. Flow path 34b can comprise interconnect tubing fixedly attached to upper polymer block 34 and to polymer storage container 25 through bottle cap 44 with a hole permitting passage of a polymer supply tube therethrough. According to various embodiments, fresh polymer 34c can be held in polymer storage container 25. Polymer storage container 25 can be connected to an end of flow path 31a via flow path 34b (also referred to as a polymer supply tube) using a polymer storage container connector. In various embodiments, the polymer storage container connector can comprise a first valve (check valve) V1 that can be provided between an end of flow path 34b and flow path 31a to allow one-way flow of the polymer from polymer storage container 25 to upper polymer block 34.

According to various embodiments, when a pin valve PV (also referred to as a buffer valve) at a lower polymer block 15c (described below) is closed, and piston 102 of polymer-delivery pump 31 is withdrawn or reciprocated in a first direction to expand the volume of chamber 104, thereby reducing pressure, fresh polymer 34c in polymer storage container 25 can be filled or drawn into chamber 104 (also referred to as an internal bore) of polymer-delivery pump 31 via tube path 34b and flow path 31a. When piston 102 is aspirating, pin valve PV can be closed and the array can be maintained in water, in a buffer solution, or in another electrically conducting liquid. When pin valve PV is closed, and piston 102 of polymer-delivery pump 31 is moved or reciprocated in a second direction to reduce the volume of the chamber 104, the fresh polymer in chamber 104 can be forced out of an opening of the chamber and injected into capillaries 3a through flow path 31b and flow path 31c. In various embodiments, the amount to electrophoresis medium that is replaced is no more than about 10% of the total volume of the capillary array. In other embodiments, the amount to be replaced is less than about 100% of the total volume of electrophoresis medium in the capillary array.

Controller 150, as shown in FIG. 7, can comprise a computing device such as, for example, a processor, microprocessor, or microcontroller device that executes a sequence of programmed instructions. In various embodiments, such a device can execute a sequence of instructions such that less than 49% of the total volume of electrophoresis medium in the capillary array will be replaced, for example, no more than about 10% of the total volume of electrophoresis medium is replaced in each capillary between each electrophoresis run.

The programmed instructions can result in replacement of no more than 10% of the total volume of electrophoresis medium in a capillary array. Controller 150 can further comprise a sequence of programmed instructions that, when executed by the processor, microprocessor, or microcontroller device, cause the device to be configured to perform the operations described herein. In various embodiments, the sequence of programmed instructions can be stored or embodied in firmware device 165. In various embodiments, firmware 165 can be, for example, a Programmable Logic Array (PLA).

Other embodiments are possible. For example, the instructions can be stored or encoded using a Read Only Memory (ROM), Programmable ROM (PROM), Erasable PROM (EPROM), or similar such device that provides non-volatile storage. The instructions can be read into non-volatile memory such as, for example, Random Access Memory (RAM), at time of execution, although in other embodiments, the instructions are not read into such a memory. In various embodiments, the instructions can be implemented using a programming language such as, for example, the Standard Commands for Programmable Instrumentation (SCPI) standard programming language. SCPI comprises a standard set of commands to control test and measurement devices. In various embodiments, the sequence of programmable instructions can cause controller 150 to reciprocate pump piston 102 and open and close valves as described above to perform the polymer fluid charging operations described herein.

In various embodiments, controller 150, shown in FIG. 7, can maintain a constant fluid pressure level in polymer flow path 31a through 31d (FIG. 8) during the drawing and filling operations described above by controlling the speed of movement of pump piston 102 by controlling the drive current provided to stepper motor 160 (FIG. 7). In various embodiments, PDP 31 output pressure can be monitored at production time (such as, for example, at the factory) to determine the stepper motor 160 current value that generates 1000 psi. In various embodiments, the stepper motor 160 current value that generates 1000 psi can vary among different units from about 0.18 Amps to 0.35 Amps. This current value can be stored in a file and provided to controller 150 at startup initialization. In various embodiments, the current value can be stored in the “calib.ini” file (for example, calibration initialization file). In operation, controller 150 can cause the amount of current equal to the current value received from a calibration file to be provided to stepper motor 160. Upon achieving a pressure in the polymer flow path of about 1000 psi, the rotational movement of stepper motor 160 can be stopped. As polymer is pushed into the capillaries, the pressure in the polymer flow path can be reduced and stepper motor 160 can start again until the pressure reaches 1000 psi, at which point stepper motor 160 stalls. This process can be completed until the desired volume of capillary fill is complete. In various embodiments, the amount of electrophoresis medium in the capillary array that can be replaced can be an amount equal to less than 49% of the array volume, or no more than about 10% of the array volume.

In various embodiments, controller 150 can monitor the speed of pump piston 102 to detect a leak condition. For example, if controller 150 determines that pump piston movement exceeds a predetermined threshold, controller 150 can stop pump piston 102 and report an error or leak condition to alert an operator to take corrective action.

In various embodiments, controller 150, as shown in FIG. 7, can be provided in communication with a computing system (not shown) via computer/network interface 170. In various embodiments, computer/network interface 170 can comprise an Ethernet interface. Controller 150 can communicate with a standalone computer or with one or more networked computers. In various embodiments, controller 150 can accept human operator input via interface 170 from a keyboard, mouse, or other such input and selection device. Controller 150 can also output status information to the human operator using a display of a computer via interface 170. In various embodiments, the display can be a Graphical User Interface (GUI). In various embodiments, controller 150 can exchange information over interface 170 in accordance with the Transport Control Protocol/Internet Protocol (TCP/IP). Controller 150 can, in various embodiments, exchange information in the form of interactive pages such as, for example, HyperText Markup Language (HTML) formatted pages using the HyperText Transport Protocol (HTTP).

BioMonitor software service (Applied Biosystems, Foster City, Calif.) can be used to remotely monitor the system over the internet, for example, by technical support or field service personnel.

In various embodiments, the polymer can comprise the electrophoresis medium inside capillaries 3a. A desired percentage of the electrophoresis medium, after one or more electrophoretic runs, can be discharged from capillaries 3a through injecting end 3b of the capillaries by charging the capillaries with the desired amount of fresh electrophoresis medium in accordance with the foregoing operation. According to various embodiments, the electrophoresis medium 34c and sample can be discharged out through injecting end 3b shown in FIG. 7. According to various embodiments, the separation medium 34c can be partially replaced per analysis of one sample, and additional fresh separation medium 34c can be used for analysis of another sample. In various embodiments, less than 49% of the total volume of electrophoresis medium in the capillary array can be replaced, or no more than about 10% of the total volume of electrophoresis medium can be replaced in the capillary array between each electrophoresis run.

According to various embodiments, as shown in FIG. 8, tube path 15b (also referred to as an interconnect tube) can be provided between flow path 31d in upper polymer block 34 and flow path 15b from lower polymer block 15c to connect them for fluid communication. Lower polymer block 15c can comprise protrusion part 15c′ protruding downward. The pin valve PV, for opening and shutting end opening 15d of the buffer solution flow path, can be supported in lower polymer block 15c. A tip end of the pin valve PV can reach the interior of protrusion part 15c′. The electrophoresis or separation medium can be filled in flow path 31d in upper polymer block 34, tube path 15b, and the buffer solution flow path in lower polymer block 15c. Buffer solution 15a can be filled in buffer storage container 15. The electrophoresis or separation medium can be placed in buffer storage container 15 as an alternative or in addition to the buffer solution. The electrophoresis or separation medium and buffer solution 15a can be in contact with each other at the end opening 15d of the buffer solution flow path.

During electrophoresis, pin valve PV can be moved to the withdrawing direction (upward in the figure) to provide a conductive pathway through valve PV. The tip end of electrode 6b can be grounded. Upon opening pin valve PV, an electrification path can be formed between electrode 6a, as seen in FIG. 7, and electrode 6b through (a) buffer solution 11a (between electrode 6a and sample injecting end 3b of the capillaries), (b) separation medium (filled in sample injecting end 3b of the capillaries), (c) capillaries 3 through end part 3d thereof, (d) flow path 31d in upper polymer block 34, (e) tube path 15b and the flow path in lower polymer block 15c, and (f) buffer solution 15a (between end opening 15d and the electrode 6b) (FIGS. 7 and 8).

Therefore, when pin valve PV is opened, and a voltage is applied between electrode 6a and electrode 6b with direct current power supply 21 (FIG. 7), such a voltage can be applied between both the ends of the electrification path; that is, a voltage can be applied to the buffer solutions positioned on both ends of the separation medium, which are present along the electrification path. Consequently, an electric current can be created in the separation medium in capillaries 3a.

Pin valve PV can be closed when the polymer is replaced in capillaries 3a. At this time, the separation medium can be injected from polymer storage container 25 to capillaries 3a using polymer delivery pump 31 to obtain the desired amount of electrophoresis medium replacement between each run. In various embodiments, less than 49% of the total volume of electrophoresis medium in the capillary array can be replaced, or no more than about 10% of the total volume of electrophoresis medium can be replaced in a capillary between each electrophoresis run.

In various embodiments, the pin valve PV can comprise a solenoid (not shown) for opening and closing the pin valve PV in response to an electrical signal from controller 150.

Any suitable electrophoresis buffer can be employed (e.g., TAE, TBE, TPE, etc.). According to various embodiments, buffer solution 11a and buffer solution 15a can be prepared with, for example, TAPS (N-tris (hydroxymethyl) methyl-3-aminopropanesulfonic acid). The tube path can be similarly immersed in buffer solution 15a.

According to various embodiments, buffer solutions 11a and 15a can be placed in buffer containers 11 and 15, respectively. Electrode 6a and electrode 6b can be immersed in buffer solution 11a and buffer solution 15a, respectively. An electrical pathway can be formed between buffer solutions 11a and 15a through the separation medium in the capillaries.

An upper surface of buffer solution 15a can be positioned above an end opening 15d of the buffer solution flow path. Therefore, at least a part of protrusion part 15c′ of the lower polymer block 15c can be immersed in the buffer solution 15a (FIG. 8).

In various embodiments, one or both of polymer supply tube 34b and interconnect tube 15b can comprise a tube having an inner diameter (ID) greater than about 0.060 inches. In some embodiments, the ID can be from about 0.5 mm to about 3 mm (for example, from about one to about two mm, or about 1.57 mm). The tubing can comprise a material that offers high burst pressure and good chemical compatibility. In various embodiments, the tubing can comprise RADEL® tubing. In some embodiments, the tubing is transparent or semi-transparent, so that users can ascertain visually whether or not bubbles are present therein. Embodiments of the methods can use a system that can avoid spatially restricted areas (for example, using large-ID tubing), which can help to minimize localized polymer hot spots as could otherwise occur if bubbles are formed. In various embodiments, the channels, flow paths, chambers, etc. within the upper and lower blocks have IDs at least as great as the ID of the interconnect tubing.

According to various embodiments, electrophoresis medium 34c can be filled in the capillaries 3a using the polymer-delivery pump 31. For example, 1, 2, 4, 8, 16, 32, 48, 96, 384, or more capillaries (3a) can be used. Subsequently, a sample comprising a polynucleotide, for example, a sample comprising DNA fragments of different respective lengths can be introduced to capillaries 3a through their injecting ends 3b. Injecting ends 3b can be immersed in buffer solution 11a contained in buffer container 11.

A voltage, for example, from about 7.5 kV to about 20 kV (e.g., 10 kV), or more, can be applied between electrode 6a (cathode) and electrode 6b (anode) with direct current power supply 21 (FIG. 7). Consequently, the DNA molecules will migrate toward the electrode 6b (electrophoresed) due to their negative charge. Differences in the electrophoretic migration velocity of the DNA molecules can occur and can, for example, correspond to the base lengths thereof. The molecules having smaller base lengths exhibit larger electrophoresis migration velocities thereby requiring shorter periods of time to reach a detecting portion of the system. Upon irradiating the sample (e.g., DNA molecules) reaching the detecting portion, with light, identification markers (e.g., fluorophores) attached to the DNA can be excited to cause detectable emission (e.g., fluorescence). The emission can be collected and imaged onto a sensing device, such as a CCD image sensor provided in a CCD camera. According to various embodiments, DNA molecules can be distinguished by electric signals obtained from the CCD camera, and thus the DNA can be analyzed. Consequently, a sample containing DNA fragments can be subjected to electrophoresis, and fluorescence from the sample can be detected in the course of electrophoresis, whereby DNA base sequencing can be carried out for determining the base sequence.

The following example represents various embodiments of the present teachings, and is not meant to be limiting in any way whatsoever.

### EXAMPLE

Three 3730x1 Genetic Analyzer instruments were used to investigate the effects of altering capillary or capillary array fill volumes and polymer squirts on capillary electrophoresis runs and the analytic information obtained during repeated electrophoresis runs. This can provide, inter alia, an understanding of the affect of partially filling an array or a single capillary with polymer in the event of a pin valve malfunction on the capillary array instrument. Additionally, the experiments can provide information concerning the effect of partial replacement of electrophoresis media between electrophoresis runs or sample analysis.

The experiments involved looking at the effect on data obtained during multiple runs and sample analysis of varying three possible parameters relating to filling of a capillary with electrophoresis medium, for example, polymer during or between electrophoresis runs. The three parameters were the array fill, the block purge, and the polymer squirt or pulse.

“Array fill” should be understood to mean that volume which will refill, replace, or recharge the capillaries in a capillary array. Thus, the array fill for a capillary array will depend on the number and volume of capillaries in a capillary array of the capillary electrophoresis apparatus.

“Block purge” should be understood to mean a volume used for purging tubing between the polymer deliver pump (PDP) and a lower block (for example, see FIGS. 7 and 8) of a capillary electrophoresis system with polymer prior to filling the array.

“Polymer squirt or pulse” should be understood to mean that volume of electrophoresis medium that will be forced in a capillary in the capillary array following closure of the pin valve.

In the drawings, CxO refers to the crossover point, which is determined from a plot of peak widths (measured at full-width-half-maximum) vs. fragment length and the peak spacing vs. fragment length. Peak spacing is calculated by first plotting the migration time of the fragments as a function of fragment length. The peak-to-peak spacing is extrapolated for fragments differing by 1 bp in size. The crossover point is the point at which the peak width and the peak spacing curves overlap.

In the drawings, 500 MT refers to the migration/electrophoresis time of the 500 bp fragment in the TET700 standard.

In the “box and whisker” plots shown in the drawings, outliers have not been included, the top whisker represents the 95th percentile, the bottom whisker represents the 5th percentile, the upper boundary of the box represents the 75th percentile, the lower boundary of the box represents the 25th percentile, the line through the middle of the box is the median not including the outliers, the dot in the box is the average not including the outliers. The scatter plots shown below the respective box and whisker plots represent all the data points including outliers. The outliers, which were removed, were those data points corresponding to fragments having less than 200 base pairs and those having greater than 900 base pairs.

In the drawings, the Q20 PLOR score refers to a Phred length of read quality control score generated by a phred base-calling algorithim. The score is also known as a phred 20 read length. More details about the phred algorithim can be found, for example, in Ewing et al., Base-Calling of Automated Sequencer Traces Using Phred, Genome.org, Volume 8, issue 3, 175-185 (March 1998), Department of Molecular Biotechnology, University of Washington, Seattle, Wash. 98195-7730 USA; 2 Genome Sequencing Center, Washington University School of Medicine, Saint Louis, Miss. 63108 USA, which article is incorporated herein in its entirety by reference.

The experimental results demonstrated that only partially filling of an array with POP-7™ polymer (Applied Biosystems, Foster City, Calif.) resulting from, for example, a polymer squirt or pulse, can have little or no affect on the resolution of components and/or migration rate of a sample being analyzed. In some embodiments, replacement volumes of less than about 10% can be used, and if any degradation of analytic results are noticed such degradation can be factored into the data analysis interpretation. If there is no array fill combined with no polymer pulse (squirt) in the array port there can be a dramatic drop in Q20 PLOR scores after only one or two runs. The drop in the Q20 PLOR can presumably be attributed to a slower migration rate and peak broadening of the sample being analyzed. In some embodiments, only a minimal volume of electrophoresis or separation medium can be replaced between electrophoresis runs and reliable results from each run can still be obtained.

### Experimental Set-Up

Reagents used in Experiment:
Polymer—POP-7™
Standards—long read standard Big Dye Terminator Version™ 3.1 (LRS BDTv3.1) (available from Applied Biosystems, Foster City, Calif.), and a DNA standard comprising 18 different base pair fragments ranging in length from 50 to 700 base pairs and each labeled with TET dye (the set being referred to herein as “TET700”)
10× Buffer—3730 10× Running Buffer with EDTA (Applied Biosystems, Foster City, Calif.)

Instruments used in Experiment:

3730x1 Genetic Analyzer (Applied Biosystems)—1403-010 (C10), 1403-011 (C11) and 1409-003 (D03)

### Experimental Conditions

Sample Plates—A batch of ˜160 96-well sample plates was made at one time. Each plate had randomly distributed 32 wells each of long read standard (LRS) Big Dye Terminator (BDT) Version 3.1, TET, and blank (EDTA in water), respectively. The plates are film sealed and stored in a refrigerator. Each cap sees the same sample all the times.

Run Module—StdSeq36_POP7, 1 hour run module. This refers to run parameters for the instrument.

Run Setup—2 injections per well, 10 plates per sample set, 20 runs per day setup. Buffer and water jars are cleaned and replaced with fresh buffer and water every 2 days of running.

Total Number of Runs at the End of Experiment

1403-010 (C10)—330 Runs

1403-011 (C11)—371 Runs

1409-003 (D03)—375 Runs

Experiment and Results:

Reduced Fill Volume Experiment:

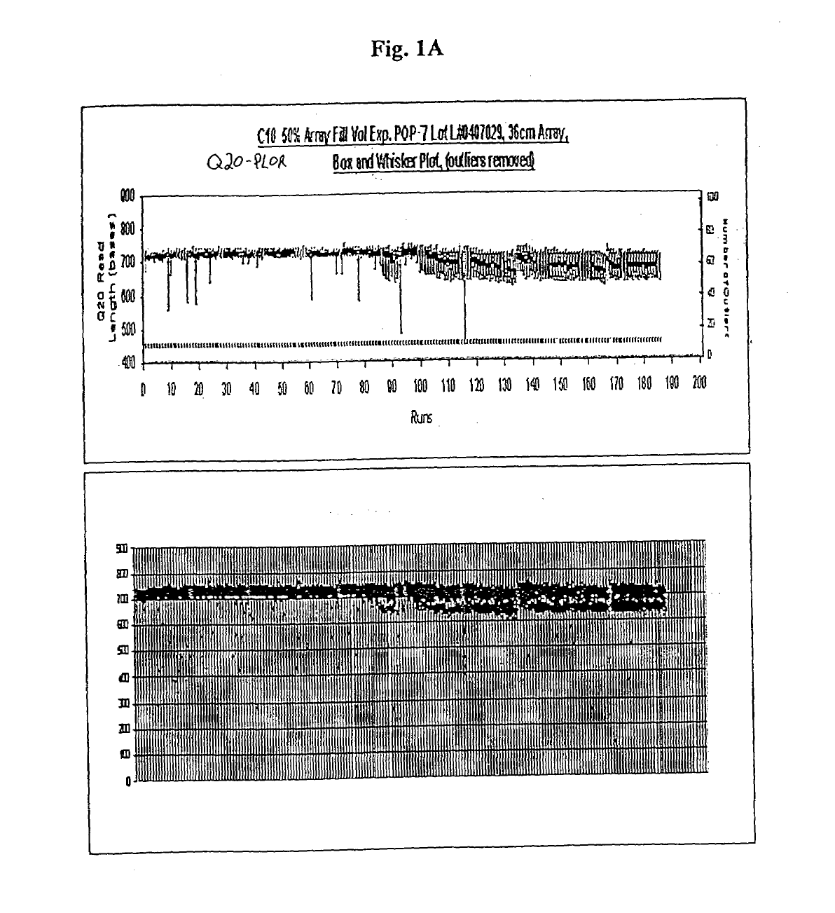

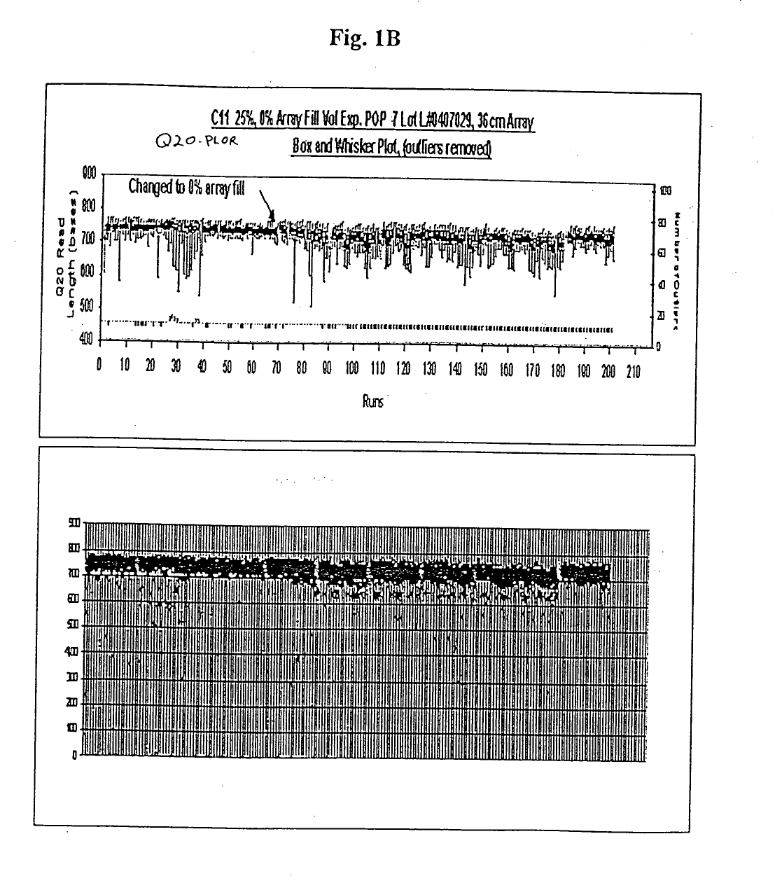

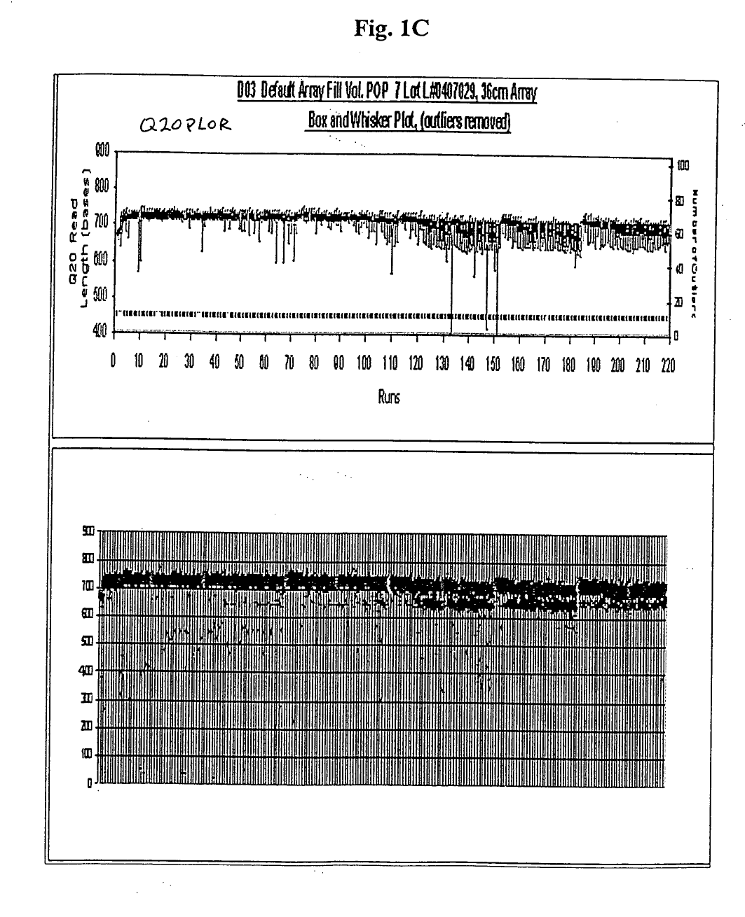

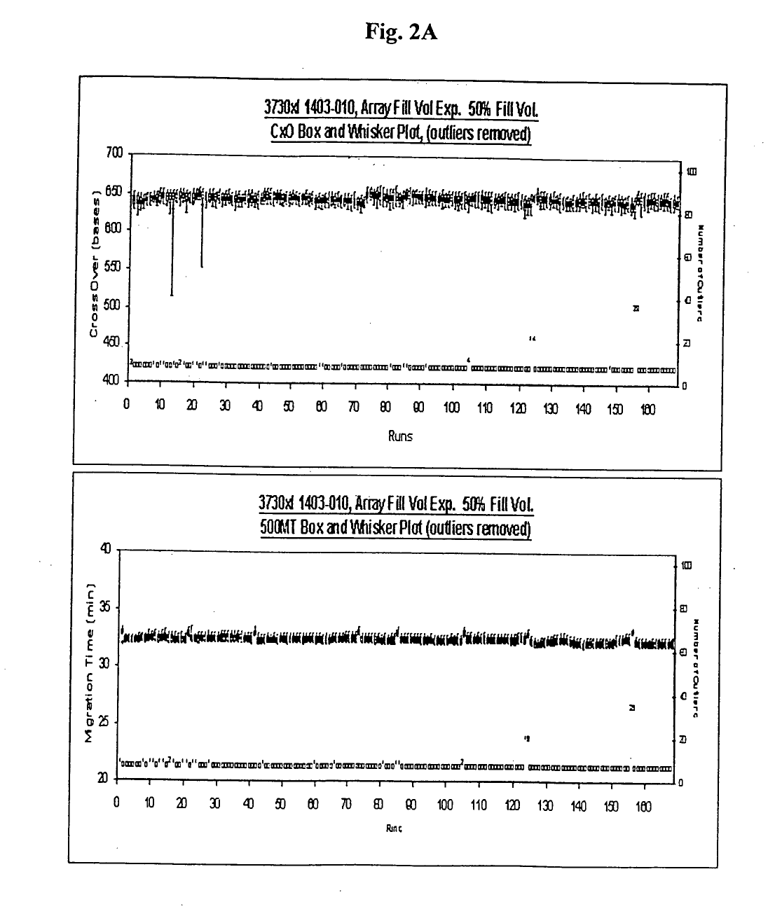

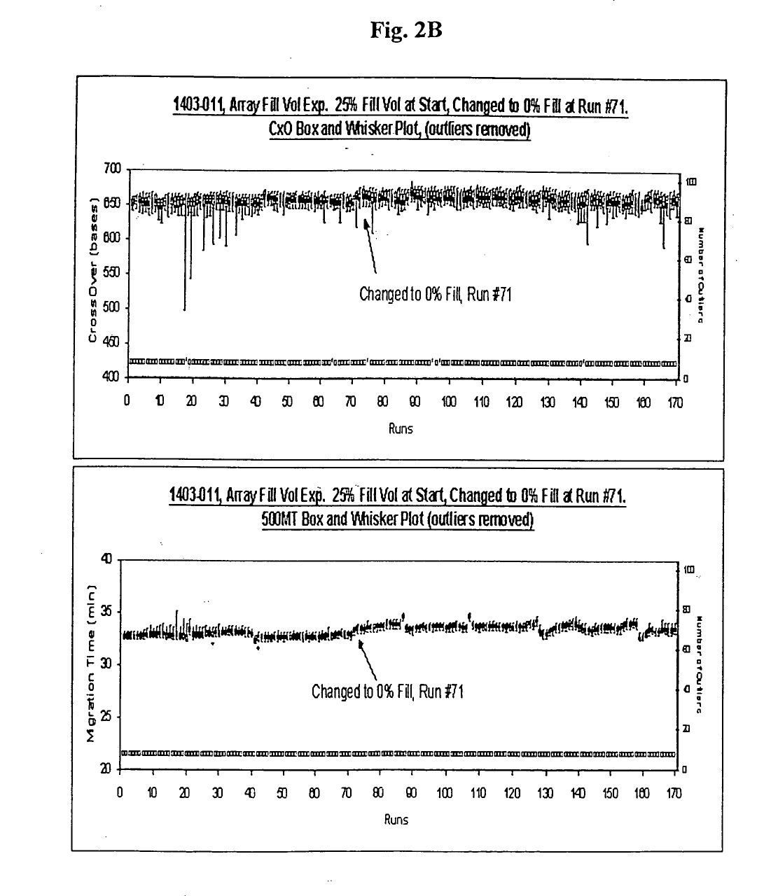

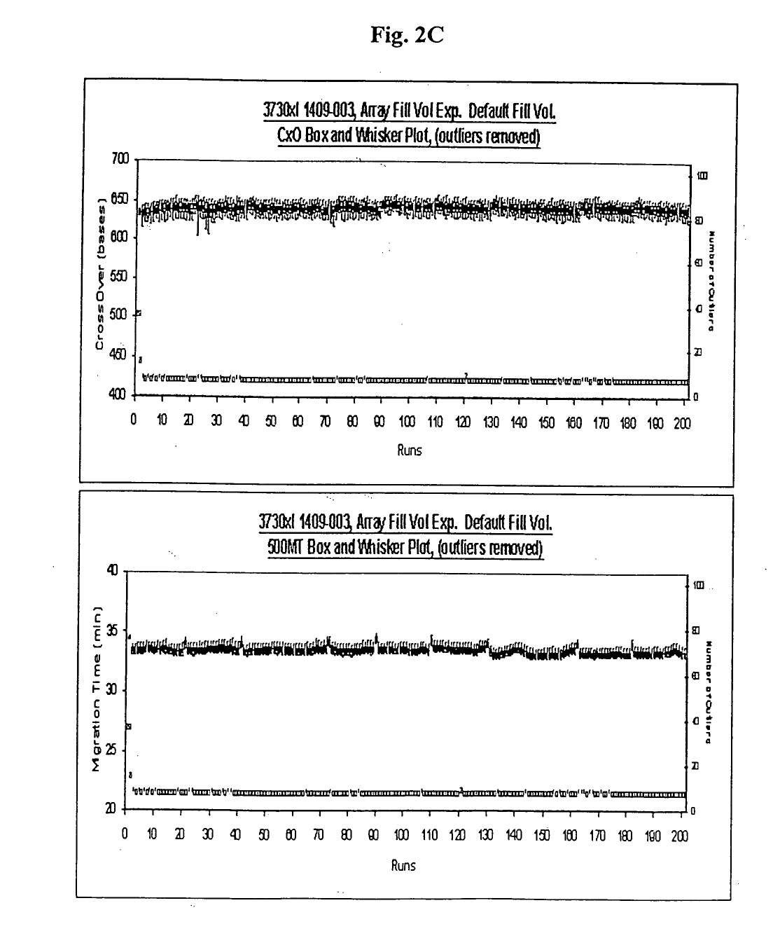

The default array fill volume in a 3730x1 Genetic Analyzer instrument is 2× the capillary array fill volume. The instrument run module was changed from the default setting for instruments C10 and C11 to use 50% and 25% of the array fill volume, respectively. The run module in instrument D03 was not changed and was run with C10 and C11 as a control instrument. After seeing little or no affect on resolution of the data obtained using 50% or 25% of the array fill volumes on both instruments C10 and C11, the array fill volume was changed to 0% at run #71 on instrument C11. Even after the change to 0% fill volume, the Q20 PLOR score stayed unchanged for over the next 100 runs. As shown in FIGS. 1A-1C, there was little or no difference in the Q20 PLOR data between instruments C10, C11 and D03. Reduced array fill volume had no affect on the crossover value and 500 bp migration time as well. The TET700 DNA standard data from all 3 instruments is shown in FIGS. 2A-2C.

No Block Purge, Polymer Squirt (Pulse) and No Array Fill:

During each run in the default 3730x1 run module, tubing between the PDP (For Example, see FIG. 8, Feature 31) and the lower block (FIG. 8, Feature 15) is purged with polymer prior to the array being filled. This is known as “Block Purge.” In the default condition, after the block purge, the array gets filled with 2× array volume, then the instrument goes through a “Pre-Run”. Following the “Pre-Run,” the array port area gets a “Polymer Squirt (Pulse)” with 4% of the array volume. The sample then gets injected and the electrophoresis starts.

After observing that significantly decreasing and even eliminating the array fill during each run had little or no affect on the resolution in some experiments, additional modifications were made in the run module. On instrument C10, the run module was changed from the default module to remove the Block Purge, Polymer Squirt and Array Fill. In other words, there was no change of electrophoresis medium between electrophoresis runs. With this modified module on instrument C10, the polymer was stagnant during the run. On instrument C11, the module was changed from default run module to remove the Polymer Squirt and Array Fill while keeping the Block Purge. The tubing between the PDP and lower block was flushed with fresh polymer at every run but the polymer was stagnant inside the capillary. Instrument D03 continued to run with the default run module as a control instrument.

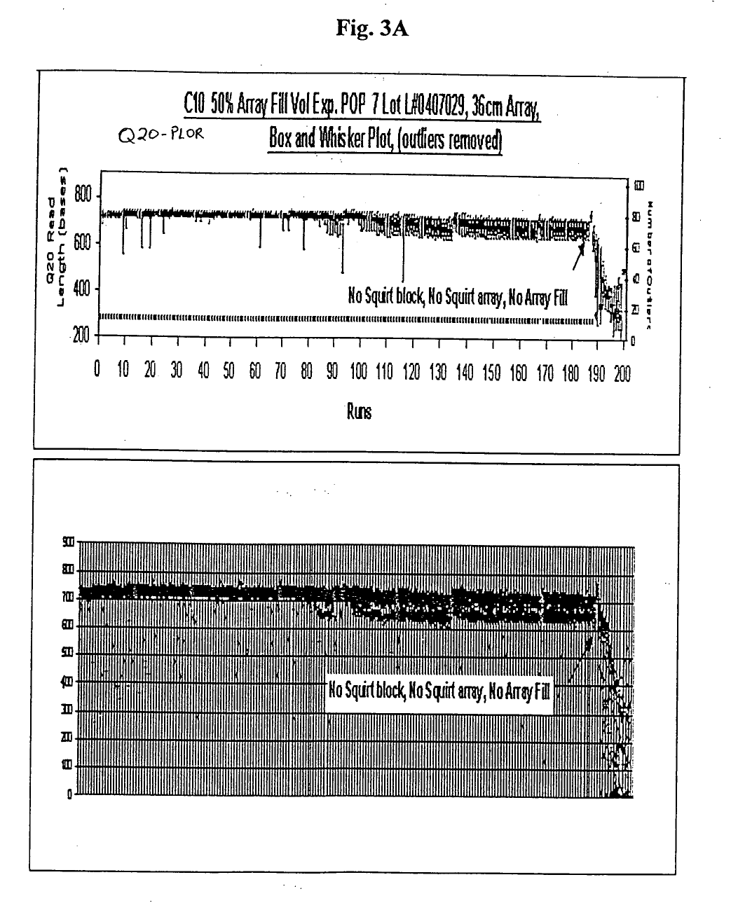

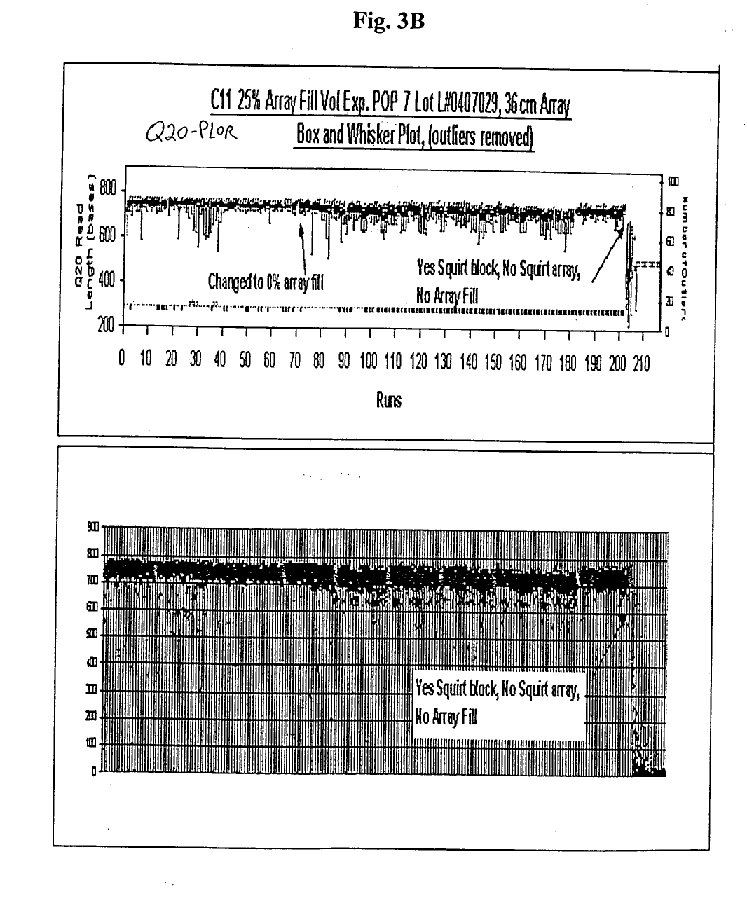

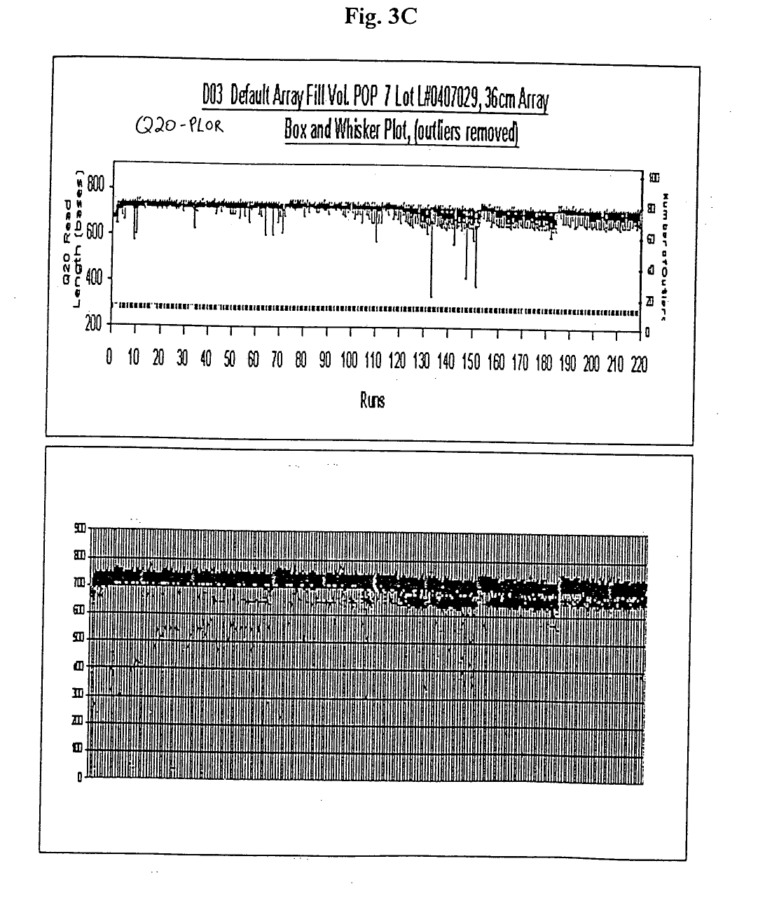

FIGS. 3A-3B demonstrates that not having any fresh polymer pumped into the capillary at the start of a new run can affect the quality of the data obtained compared to that under default conditions (FIG. 3C). The Q20 PLOR dropped more than 100 bp within 3 runs on instruments C10 and C11 and continued to get worse with additional electrophoresis runs.

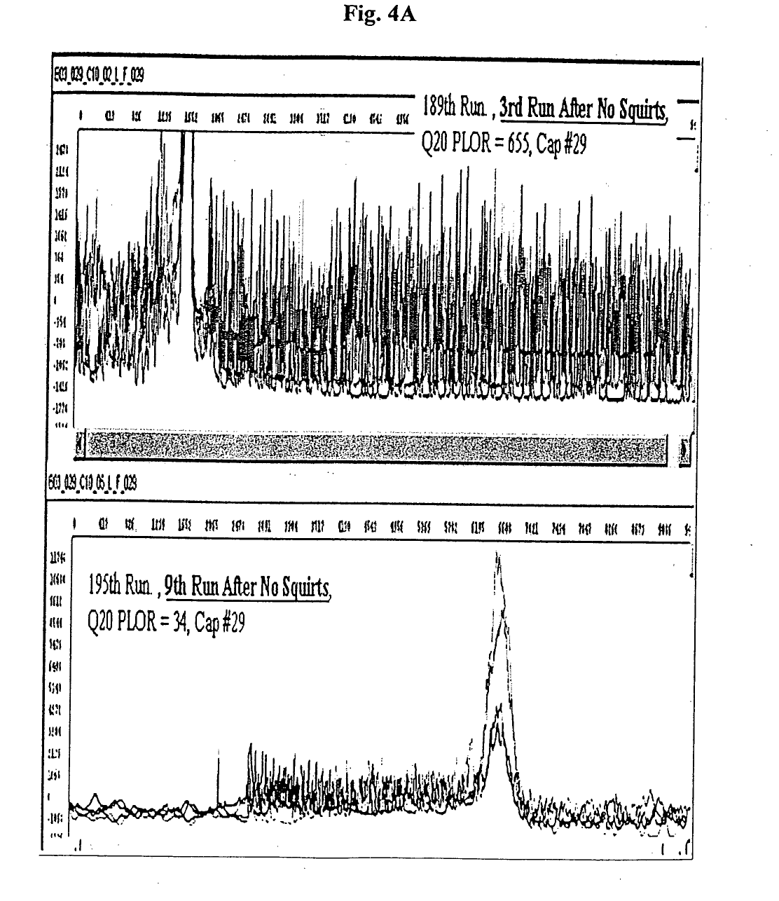

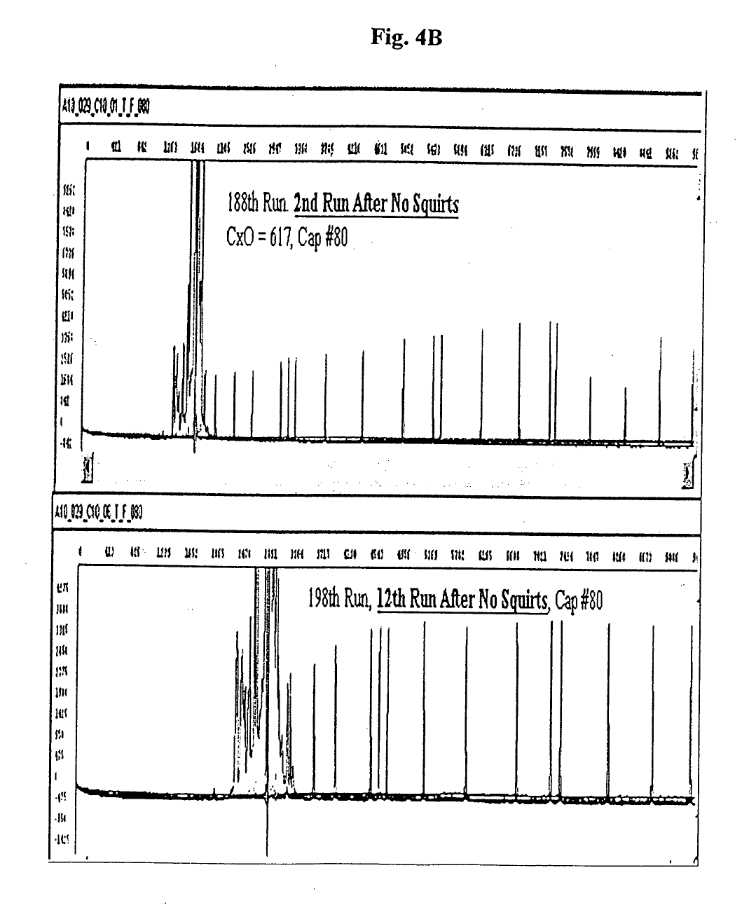

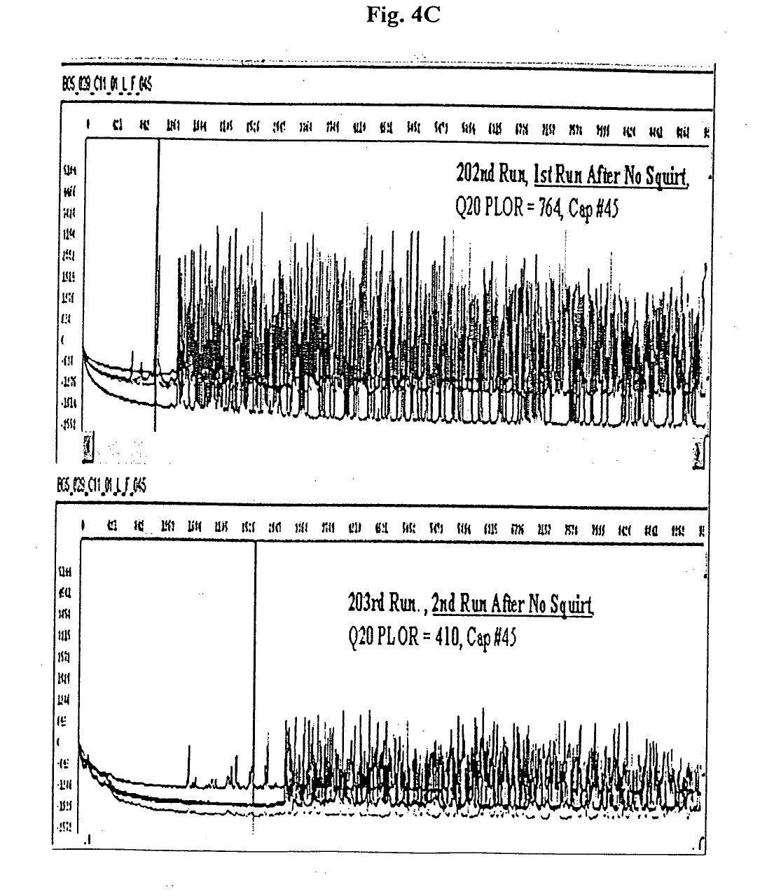

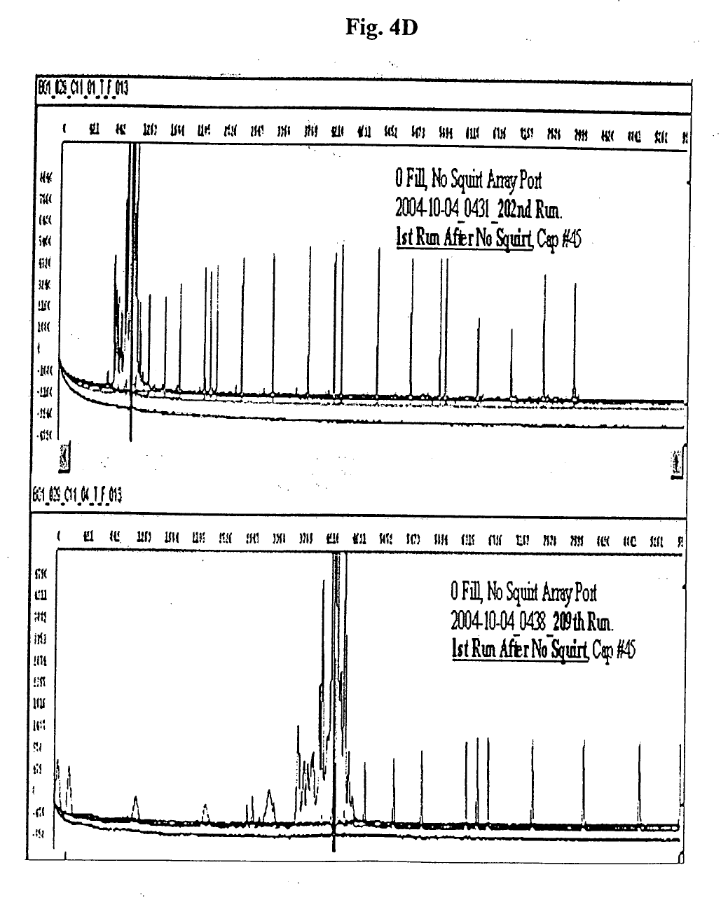

Analyzing the electrophoresis run data with SeqAnal Sequencing Analysis Software (Applied Biosystems, Foster City, Calif.) showed that the decrease in Q20 PLOR was due largely to slower migration rate and somewhat to peak broadening. FIGS. 4A-4D show that both the LRS and TET samples migrated slower on subsequent runs when no fresh polymer was pumped into the capillary. This resulted in cutting-off the data at the end and also gave lower Q20 PLOR.

No Damage to Array Upon Returning to Default Condition:

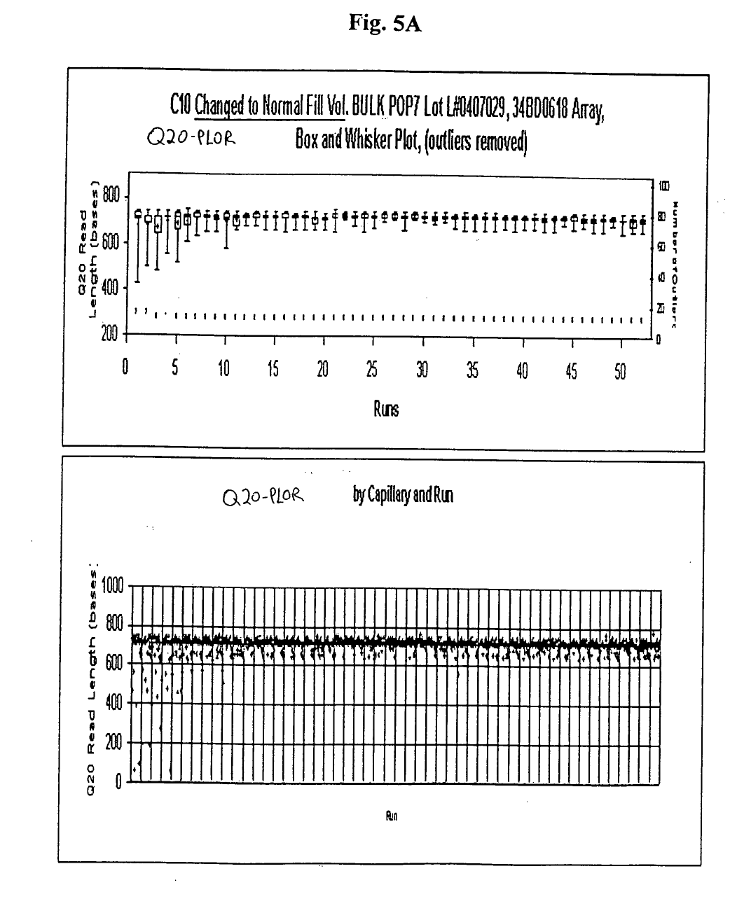

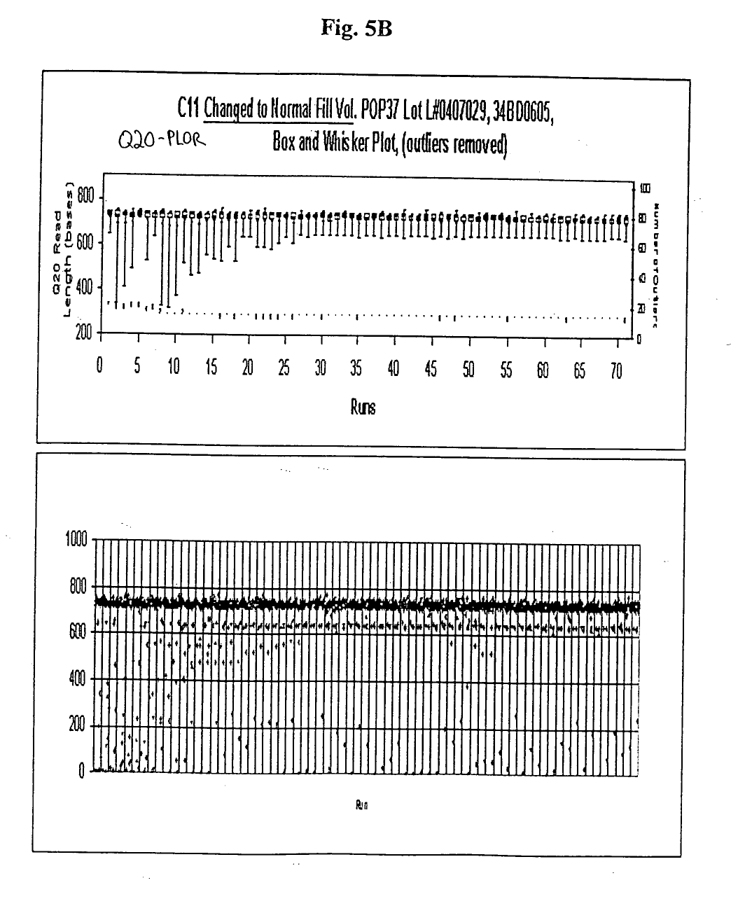

After seeing a significant drop in Q20 PLOR on instruments C10 and C11 (as shown in FIGS. 3A-3B), the run module on each instrument was changed to the default run conditions and the data collection was resumed. The quality of the data improved to typical Q20 PLOR for this run module (StadSeq36_POP7) in less than a day's run as shown in FIGS. 5A-5B (for simplicity, preceding runs are not shown in the charts). This suggests that performing electrophoresis without adding any fresh polymer into the capillary during the experiment did not permanently damage the array.

Squirts Not Needed:

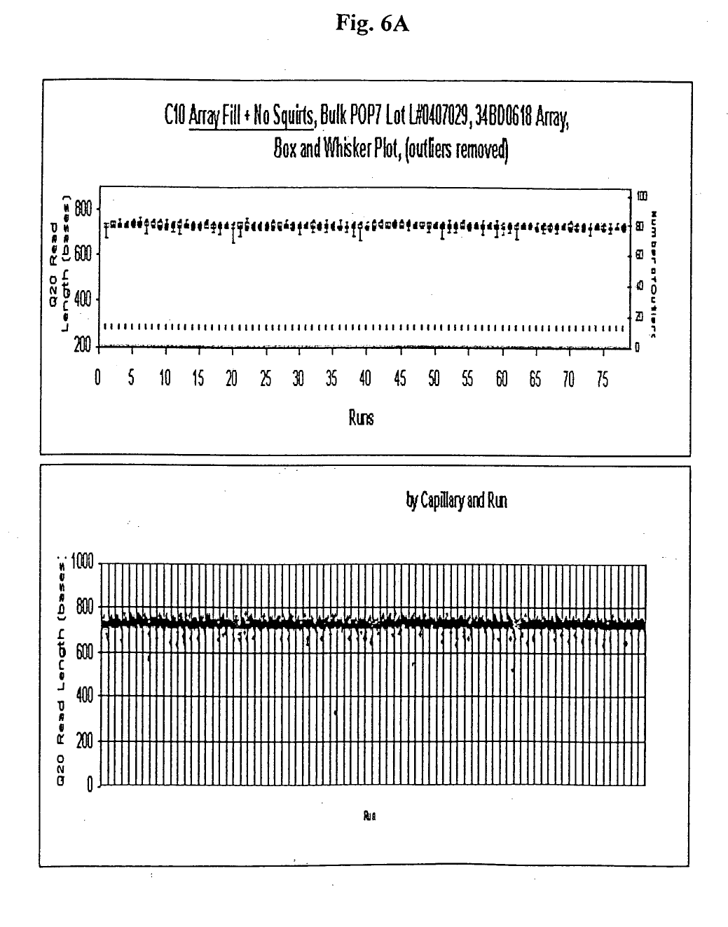

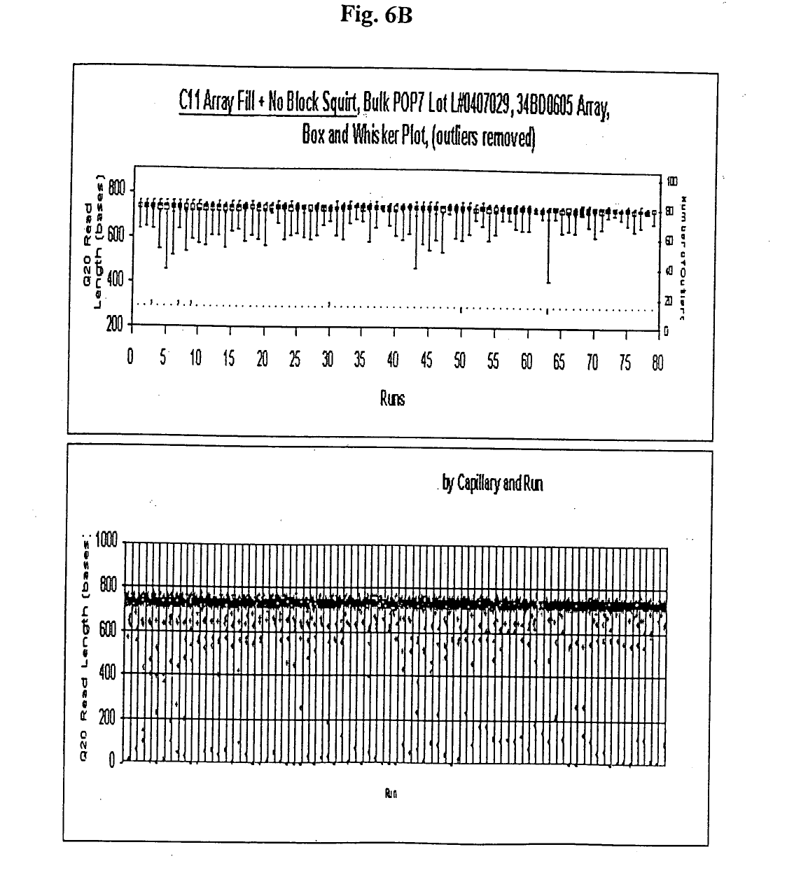

The Q20 PLOR data shown in FIGS. 6A-6B suggest that “squirts” may be removed during each electrophoresis run. The data shown in FIGS. 6A-6B is a continuation of the data shown in FIG. 5. However, data from parts of the previous run were intentionally left out in FIG. 6 for simplicity. The run module was modified again, this time removing only the “squirt(s)” and leaving the array fill in the module. Instrument C10 had both “squirts” removed and C11 had only the “block squirt” removed.

Conclusion:

Data from array fill volume experiments on three 3730x1 Genetic Analyzer instruments demonstrated that a capillary does not need to be flushed with fresh polymer prior to start of each electrophoresis run. Some experimental results suggested that as little as 4% of the capillary fill volume of polymer pumped into a capillary was enough to maintain good resolution of data. Other experiments, however, suggested that replacing as little as 4% of the capillary fill volume can result in less than optimal data being obtained from samples during electrophoresis. Thus, electrophoresis medium can be saved and electrophoresis runs can be conducted more economically by a minimal addition of the medium between each run. The amount of electrophoresis medium and the reduced costs of such a method, can depend on the quality of data one of skill in the art wishes to obtain such a determination of cost versus benefit and reducing electrophoresis medium usage can be determined by one of skill in the art using the methods of the present teachings.

All literature and similar materials cited in this application, including but not limited to, patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

While various embodiments describe a multi-capillary electrophoresis instrument it is understood that the ideas extend, among other things, to a single capillary system or other electrophoresis approaches such as channel plates.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

What is claimed is:

1. A method comprising:
providing an electrophoresis system comprising at least one capillary and a refilling device, the refilling device comprising a pump in fluid communication with a block, the block also in fluid communication with the at least one capillary, the at least one capillary has an internal volume, and the at least one capillary is filled with an electrophoresis medium;
electrophoresing at least one first sample in the at least one capillary;
thereafter, providing to the at least one capillary from the refilling device a volume of electrophoresis medium that is no more than 49% of the internal volume of the at least one capillary; and
electrophoresing at least one second sample in the at least one capillary after providing the volume of electrophoresis medium.

2. The method of claim 1, wherein the providing to the at least one capillary comprises injecting electrophoresis medium.

3. The method of claim 1, wherein the at least one capillary is provided with a volume of electrophoresis medium equal to no more than about 25% of the internal volume of the at least one capillary.

4. The method of claim 1, wherein the providing of not more than 49% of the volume of electrophoresis medium results in replacing at least about 10% of the volume of electrophoresis medium that had been present in the at least one capillary.

5. The method of claim 1, wherein the providing of electrophoresis medium comprises injecting the electrophoresis medium at a pressure of greater than about 160 pounds per square inch.

6. The method of claim 5, wherein the providing of electrophoresis medium comprises injecting the electrophoresis medium at a pressure of at least about 1000 pounds per square inch.

7. The method of claim 1, wherein the at least one capillary is inserted directly into the block.

8. The method of claim 1, wherein the electrophoresis medium comprises an acrylamide polymer.

9. The method of claim 8, wherein the acrylamide polymer comprises a non-crosslinked polymer.

10. The method of claim 1, wherein the providing to the at least one capillary no more than 49% of the total volume of the electrophoresis medium comprises pumping the electrophoresis medium from the refilling device with a pump system, the pump system comprises:
the pump and the block wherein an outlet opening and a fluid chamber are formed in the block, wherein the fluid chamber is in fluid communication with the outlet opening;
a buffer storage container connector adapted to retain a buffer storage container in fluid communication with the fluid chamber;
a polymer container connector adapted to form a fluid communication with polymer in a polymer container; and
a reciprocating piston pump in fluid communication with the fluid chamber and the polymer container connector.

11. The method of claim 1, wherein there is no tubing between the pump and the at least one capillary.

12. A method comprising:
providing an electrophoresis system comprising at least one capillary and a refilling device, wherein the at least one capillary has an internal volume;
filling the at least one capillary with an electrophoresis medium;
electrophoresing at least one first sample in the at least one capillary;
thereafter, providing a volume of electrophoresis medium at a pressure greater than about 160 pounds per square inch from the refilling device into the at least one capillary, wherein the volume is no more than 49% of the internal volume of the at least one capillary; and
electrophoresing at least one second sample in the at least one capillary after the providing a volume of electrophoresis medium.

13. The method of claim 12, wherein the providing of electrophoresis medium comprises injecting the electrophoresis medium at a pressure of at least about 1000 pounds per square inch.

14. The method of claim 12, wherein the providing a volume of electrophoresis medium comprises injecting the electrophoresis medium.

15. The method of claim 12, wherein the at least one capillary is provided with a volume of electrophoresis medium equal to no more than about 25% of the internal volume of the at least one capillary.

16. The method of claim 12, wherein the providing no more than 49% of the internal volume results in replacing at least 10% of the electrophoresis medium that had been present in the at least one capillary.

17. The method of claim 12, wherein the electrophoresis medium comprises an acrylamide polymer.

18. The method of claim 17, wherein the acrylamide polymer comprises a non-crosslinked polymer.
